(19) United States
(12) Patent Application Publication
(10) Pub. No.: US 2026/0196397 A1
(43) Pub. Date: Jul. 9, 2026

(54) IMPROVEMENTS IN CONTROL OF CURRENT SUPPLY TO A TRANSFORMER-RECTIFIER FLUX PUMP

(71) Applicant: VICTORIA LINK LIMITED, Wellington (NZ)

(72) Inventors: Rodney Alan Badcock, Wellington (NZ); Bradley Leuw, Wellington (NZ); Dominic Ashley Moseley, Wellington (NZ); James Hamilton Palmer Rice, Wellington (NZ)

(73) Assignee: VICTORIA LINK LIMITED, Wellington (NZ)

(21) Appl. No.: 19/133,373

(22) PCT Filed: Nov. 24, 2023
(86) PCT No.: PCT/NZ2023/050138

§ 371 Date: May 28, 2025

(30) Foreign Application Priority Data
Nov. 29, 2022 (AU) 2022903621

(51) Int. Cl. H01F 6/00

(52) U.S. Cl. CPC H01F 6/008; H01F 6/005

(57) ABSTRACT

The technology relates to the field of superconductor transformer-rectifier flux pumps and controlling a supply of alternating current to a transformer-rectifier flux pump to charge a load. A response of the transformer-rectifier flux pump to a characterisation current supply is determined, which may comprise determining values in the flux pump corresponding to values of the applied current. For each of a plurality of target values of load current to be supplied to the load, values of the current supply are calculated. The supply of current to the flux pump is controlled accordingly. The supply may be modified based on feedback received from the flux pump, for example sensors measuring values on the secondary side of the transformer.

### 1. FIELD OF THE TECHNOLOGY

The technology generally relates to the field of superconductors and, in particular, to superconductor transformer-rectifier flux pumps. More particularly, the technology relates to methods and apparatus for controlling a supply of alternating current to a transformer-rectifier flux pump to charge a load.

### 2. BACKGROUND TO THE TECHNOLOGY

Superconducting circuits have a wide range of applications. Examples of applications for systems including superconducting circuits include (and are not limited to): superconducting magnets; flux pumps; fault current limiters; magnetic energy storage systems; space propulsion; nuclear fusion; nuclear magnetic resonance (NMR); magnetic resonance imaging (MRI); levitation; water purification and induction heating.

Many applications including superconducting circuits require low-voltage high-current power supplies, for example in strong high temperature superconducting (HTS) magnets for applications such as fusion. To meet these requirements, traditional power supplies require a large amount of space resulting in a large infrastructure challenge. Also, connecting a normal conducting circuit to a superconducting circuit housed in a cryostat introduces a large thermal load through the physical contacts into the cryostat, creating a cooling challenge. This requires sophisticated thermal design and imposes a considerable heat penalty on the cryostat and cooling system. It also incurs a significant voltage drop across the normal conducting circuit components, necessitating a significantly higher-power supply than required solely to energise the superconducting coil.

Superconducting power supplies help address these issues. Higher current densities allow the power supply to be more compact, and the ability to magnetically couple alternating current (AC) circuits without any physical contact using HTS flux pumps circumvents the cooling issue. A flux pump can be used to induce a current flow in a superconducting material without direct electrical contacts using electromagnetic flux. This allows for current to flow in the HTS circuit without requiring a normally conducting electrical connection.

In order to power a HTS magnet, a large direct current (DC) is needed, requiring rectification to convert the AC (a current which periodically reverses in direction) into direct current (a current which flows only in one direction). Therefore, one type of flux pump is the transformer-rectifier flux pump (TRFPs) which generally uses a non-superconducting transformer primary coil magnetically coupled to a superconducting secondary coil with a rectifying circuit coupled to the secondary coil.

TRFPs have some known problems. For example, remnant flux during the charging process can progressively offset the transformer core. This offset limits the absolute current generated in the secondary circuit, altering the flux pump output. In addition, the amount of power generation may vary depending on the level of energisation of the load. This may result in an inability of the TRFP to effectively charge the load coil.

### 3. OBJECT OF THE TECHNOLOGY

It is an object of the technology to provide an improved method of controlling a supply of applied current to a transformer-rectifier flux pump to charge a load. Alternatively, it is an object of the technology to provide an improved apparatus for controlling a supply of applied current to a transformer-rectifier flux pump to charge a load. Alternatively, it is an object of the technology to provide an improved transformer-rectifier flux pump.

Alternatively, it is an object of the technology to at least provide the public with a useful choice.

### 4. SUMMARY OF THE TECHNOLOGY

According to certain aspects of the technology, there is provided a method and/or apparatus for determining how to supply applied current to a transformer-rectifier flux pump to charge a load. In other aspects of technology, there is provided a method and/or apparatus for controlling a supply of applied current to the transformer-rectifier flux pump to charge the load, for example controlling the supply based on the determination. The step of determining how to supply applied current may comprise determining the expected behaviour of the transformer-rectifier flux pump.

In certain forms, the determination of how to supply applied current to the transformer-rectifier flux pump comprises characterising a response of the transformer-rectifier flux pump to a characterisation supply of applied current. The step of characterising the response of the transformer-rectifier flux pump may comprise determining a plurality of values in the transformer-rectifier flux pump corresponding to a respective plurality of values of applied current supplied to the transformer-rectifier flux pump. One or more steps in the determination of how to supply applied current to the transformer-rectifier flux pump may occur during the charging process, i.e. after the charging of the load has commenced.

In certain forms, the determination of how to supply applied current to the transformer-rectifier flux pump comprises calculating, for each of a plurality of target values of load current to be supplied to the load, one or more waveform values of the supply of alternating current to the transformer-rectifier flux pump. In certain forms, each of the target values of load current may be calculated at one or more pre-selected increments up to a pre-selected target value of the load current.

In certain forms, each of the plurality of target values of load current may be calculated using the plurality of values determined in the step of characterising the response of the transformer-rectifier flux pump to the characterisation supply of applied current.

In certain forms, controlling the supply of applied current to the transformer-rectifier flux pump comprises modifying the supply of applied current to the transformer-rectifier flux pump during the process of charging the load. The supply of applied current may be modified based on feedback received from the transformer-rectifier flux pump, for example from one or more sensors configured to measure values of the transformer-rectifier flux pump. The sensors may measure values of a secondary side of the transformer-rectifier flux pump.

According to one aspect of the technology, there is provided a method of controlling a supply of applied current to a transformer-rectifier flux pump to charge a load. The transformer-rectifier flux pump may comprise a transformer comprising a primary coil and a secondary coil. The transformer-rectifier flux pump may further comprise a rectifier connected to the secondary coil and configured to supply a load current to a load. The secondary coil, the rectifier and the load may comprise one or more lengths of superconducting material. The method may comprise calculating, for each of a plurality of target values of load current to be supplied to the load, one or more waveform values of the supply of applied current to the transformer-rectifier flux pump. The method may further comprise controlling the supply of applied current to charge the load based on the one or more waveform values of the supply of applied current.

In certain forms, the method may comprise calculating the one or more waveform values of the supply of applied current to the transformer-rectifier flux pump for target values of load current at one or more pre-selected increments up to a pre-selected target value of the load current.

In certain forms, the one or more waveform values of the supply of applied current to the transformer-rectifier flux pump may comprise a peak value of the supply of applied current when flowing in a first direction, and a peak value of the supply of applied current when flowing in a second direction, the second direction being opposite to the first direction.

In certain forms, the method of calculating one or more waveform values of the supply of applied current to the transformer-rectifier flux pump may comprise calculating, for each of the plurality of target values of load current to be supplied to the load, one or more target voltage values for the transformer-rectifier flux pump. The method may further comprise calculating the one or more waveform values of the supply of applied current to the transformer-rectifier flux pump from the one or more target voltage values.

In certain forms, the one or more target voltage values may comprise target values of voltage output to the load. In certain forms, the target values of voltage output to the load may comprise target values of voltage across a switch connected in parallel across the load.

In certain forms, the one or more target voltage values may comprise first target values of voltage output to the load when the rectifier is in a first configuration in which a current generated in the secondary coil is supplied to the load. The one or more target voltage values may further comprise second target values of voltage output to the load when the rectifier is in a second configuration in which no current is supplied from the secondary coil to the load.

In certain forms, the method may comprise supplying a characterisation supply of applied current to the transformer-rectifier flux pump. The method may further comprise characterising a response of the rectifier and/or the load to the characterisation supply. The method may further comprise controlling the supply of applied current to charge the load based on the characterised response.

In certain forms, the method may comprise supplying the characterisation supply and characterising the response to the characterisation supply prior to commencing the supply of applied current to the transformer-rectifier flux pump to charge the load.

In certain forms, the step of supplying the characterisation supply comprises supplying a first characterisation supply of applied current to the transformer-rectifier flux pump when the rectifier is in a first configuration in which a current generated in the secondary coil is supplied to the load, and characterising a first response of the rectifier and/or the load to the first characterisation supply. The method may further comprise supplying a second characterisation supply of applied current to the transformer-rectifier flux pump when the rectifier is in a second configuration in which no current is supplied from the secondary coil to the load, and characterising a second response of the rectifier and/or the load to the second characterisation supply.

In certain forms, characterising the response of the rectifier and/or the load to the characterisation supply may comprise determining a plurality of values of voltage in the rectifier corresponding to a respective plurality of values of applied current supplied to the primary coil. The plurality of values of voltage in the rectifier may comprise values of voltage output to the load. The values of voltage output to the load may comprise values of voltage across a switch connected in parallel across the load.

In certain forms, the method may further comprise modifying the supply of applied current to the transformer-rectifier flux pump during the process of charging the load. In certain form, the supply of applied current may be modified based on feedback received from one or more sensors configured to measure values of the transformer-rectifier flux pump. In certain forms, the feedback may comprise a comparison of target values and measured values of the transformer-rectifier flux pump. In certain forms, modifying the supply of applied current may comprise using a PID loop.

In certain forms, the one or more waveform values may be values of current supplied to the primary coil. In certain forms, the transform-rectifier flux pump may comprise a magnetic field generator for applying a magnetic field to one of the lengths of type II superconducting material. The one or more waveform values may be values of current supplied to the magnetic field generator.

According to another aspect of the technology, there is provided a method of controlling a supply of applied current to a transformer-rectifier flux pump to charge a load. The transformer-rectifier flux pump may comprise a transformer comprising a primary coil and a secondary coil. The transformer-rectifier flux pump may further comprise a rectifier connected to the secondary coil and configured to supply a load current to a load. The secondary coil, the rectifier and the load may comprise one or more lengths of superconducting material. The method may comprise supplying a characterisation supply of applied current to the transformer-rectifier flux pump. The method may further comprise characterising a response of the rectifier and/or the load to the characterisation supply. The method may further comprise controlling the supply of applied current to charge the load based on the characterised response.

According to one aspect of the technology, there is provided a method of controlling a supply of applied current to a transformer-rectifier flux pump to charge a load. The transformer-rectifier flux pump may comprise a transformer comprising a primary coil and a secondary coil. The transformer-rectifier flux pump may further comprise a rectifier connected to the secondary coil and be configured to supply a load current to a load. The secondary coil, the rectifier and the load may comprise one or more lengths of superconducting material. The method may comprise controlling the supply of applied current such that a voltage generated across the secondary coil of the transformer is substantially zero when integrated over a cycle.

According to another aspect of the technology, there is provided a method of controlling a supply of applied current to a transformer-rectifier flux pump to charge a load. The transformer-rectifier flux pump may comprise a transformer comprising a primary coil and a secondary coil. The transformer-rectifier flux pump may further comprise a rectifier connected to the secondary coil and configured to supply a load current to a load. The secondary coil, the rectifier and the load may comprise one or more lengths of superconducting material. The method may comprise modifying the supply of applied current to the transformer-rectifier flux pump based on feedback received from the transformer-rectifier flux pump, for example from one or more sensors configured to measure values of the transformer-rectifier flux pump. The sensors may measure values of a secondary side of the transformer-rectifier flux pump.

According to another aspect of the technology, there is provided an apparatus for controlling a supply of applied current to a transformer-rectifier flux pump to charge a load. The apparatus may comprise a processor configured to perform the method of any one of the other aspects of the technology.

According to another aspect of the technology, there is provided a transformer-rectifier flux pump comprising a transformer comprising a primary coil and a secondary coil. The transformer-rectifier flux pump may further comprise a rectifier connected to the secondary coil and configured to supply a load current to a load. The secondary coil, the rectifier and the load may comprise one or more lengths of superconducting material. The transformer-rectifier flux pump may further comprise a current control mechanism for controlling a supply of applied current to the primary coil. The current control mechanism may be configured to perform the method of any one of the other aspects of the technology.

In certain forms, the rectifier may comprise a switching assembly comprising one or more switches. In certain forms, each switch may comprise a length of superconducting material configured to carry a switch current, wherein the length of superconducting material has a critical current. The transformer-rectifier flux pump may further comprise one or more magnetic field generators each configured to apply a magnetic field to the length of superconducting material of the respective switch. Each magnetic field generator may be configured to be selectively controlled to switch the length of superconducting material between a low-resistance state and a higher resistance state.

In certain forms, in the low-resistance state, a magnitude of the magnetic field may be relatively low such that the switch current is substantially less than the critical current and, in the higher-resistance state, the magnitude of the magnetic field may be relatively high to reduce the critical current such that the switch current approaches the critical current, is substantially equal to the critical current or is greater than the critical current of the length of superconducting material.

In certain forms, the current control mechanism may be configured for controlling a supply of applied current to the one or more magnetic field generators.

According to another aspect of the technology, there is provided a transformer-rectifier flux pump comprising a transformer comprising a primary coil and a secondary coil. The transformer-rectifier flux pump may further comprise a rectifier connected to the secondary coil and configured to supply a load current to a load. The secondary coil, the rectifier and the load may comprise one or more lengths of superconducting material. The rectifier may comprise a switching assembly comprising one or more switches. In certain forms, each switch may comprise a length of superconducting material configured to carry a switch current, wherein the length of superconducting material has a critical current. The transformer-rectifier flux pump may further comprise one or more magnetic field generators each configured to apply a magnetic field to the length of superconducting material of the respective switch. Each magnetic field generator may be configured to be selectively controlled to switch the length of superconducting material between a low-resistance state and a higher resistance state. The transformer-rectifier flux pump may further comprise a current control mechanism for controlling a supply of applied current to the primary coil and/or the one or more magnetic field generators. The current control mechanism may be configured to perform the method of any one of the other aspects of the technology.

Further aspects of the technology, which should be considered in all its novel aspects, will become apparent to those skilled in the art upon reading of the following description which provides at least one example of a practical application of the technology.

### 5. BRIEF DESCRIPTION OF THE DRAWINGS

One or more embodiments of the technology will be described below by way of example only, and without intending to be limiting, with reference to the following drawings, in which:

FIG. 1 shows an exemplary electric-field versus current graph for a high-temperature superconductor;

FIG. 2 is an illustration of graphs of electric field against current for a superconducting material when three external magnetic fields of different magnitude are applied;

FIG. 3A is a schematic illustration of an exemplary half-wave transformer-rectifier flux pump in accordance with one form of the technology;

FIG. 3B is a circuit diagram of an exemplary half-wave transformer-rectifier flux pump in accordance with one form of the technology;

FIG. 3C is a circuit diagram of the exemplary half-wave transformer-rectifier flux pump shown in FIG. 3A in a charging phase;

FIG. 3D is a circuit diagram of the exemplary half-wave transformer-rectifier flux pump shown in FIG. 3A in a maintenance phase;

FIG. 3E is an illustration of one form of half-wave transformer-rectifier flux pump represented by the circuit diagrams of FIGS. 3A-3C;

FIG. 4 is a circuit diagram of an exemplary centre-tapped full-wave transformer-rectifier flux pump in accordance with one form of the technology;

FIG. 5 is a schematic illustration of an exemplary processing system according to one form of the technology;

FIG. 6 illustrates simulated changes in flux over time in the core of transformers of conventional TRFPs for transformers having cores of a variety of cross-sectional areas;

FIGS. 7A, 7B are graphs showing the magnitude of applied current supplied to the primary coil of a transformer-rectifier flux pump against time over the course of one cycle of current for a variety of stages in the process of charging the load according to one form of the technology; and

FIG. 8 is a flow chart diagram of the process performed by the current control mechanism when performing a method to implement a PID loop according to certain forms of the technology.

### 6. DETAILED DESCRIPTION OF EXEMPLARY FORMS OF THE TECHNOLOGY

### 6.1. Superconductivity Principles

A superconductor or superconducting material is a material that exhibits zero electrical resistance below a certain temperature known as the critical temperature, T_{c}. This zero electrical resistance state is often referred to as a superconducting state. Below the critical temperature, when the material is in the superconducting state, a phenomenon known as the Meissner Effect, which is the complete expulsion of any magnetic field from the superconductor, occurs. Superconductors are perfect diamagnetic materials up until a certain magnetic field strength known as the critical field, H_{c1}. At this point the superconductor cannot keep the magnetic field out, and thus the magnetic field enters the superconductor, which transitions the superconductor from the superconducting state to a state which no longer has zero electrical resistance. This critical field also implies that there is a limit to the current that the superconductor can carry, known as the critical current, I_{c}.

There are two types of superconductors, named type I and type II. Type I superconductors are typically pure metals and behave as described above. Type II superconductors behave differently. Under applied magnetic fields below a certain magnitude (the first critical field H_{c1}) they expel flux in a similar manner to type I superconductors, however, they also display a second critical field (H_{c2}) which is always greater than H_{c1}. At fields between H_{c1} and H_{c2}, magnetic field can penetrate type II superconductors in the form of Abrikosov vortices. This creates an intermediate phase where the material can exhibit a finite small resistance while remaining fundamentally superconducting. Because of this behaviour, type II superconductors can carry much more current in an applied magnetic field than type I superconductors, making them useful for practical applications.

The critical temperature for a superconductor is conventionally defined as the temperature below which the resistivity of the superconductor drops to zero or near zero. In other words, a superconductor is said to be in its superconducting state when the temperature of the superconductor is below the critical temperature and in a non-superconducting state when the temperature is above the critical temperature. Many superconductors have a critical temperature which is near absolute zero; for example, mercury is known to have a critical temperature of 4.1K. It is however also known that some materials can have critical temperatures which are much higher such as 30K to 125K; for example, magnesium diboride has a critical temperature of approximately 39K, while yttrium barium copper oxide (YBCO) has a critical temperature of approximately 92K. These superconductors are often generally referred to as high-temperature superconductors (HTSs). HTSs are type II superconductors.

### 6.1.1. Critical Current

The critical current for a high-temperature superconductor wire or tape is conventionally defined as the current flowing in a superconductor wire/tape which results in an electric field drop along the wire of 100 μV/m (=1 μV/cm). The critical current is a function of both the superconducting material used, and the physical arrangement of the superconducting material. For example, a wider tape/wire may have a higher critical current than a thinner tape/wire constructed of the same material. Nevertheless, throughout the specification, reference to the critical current of the superconductor/superconducting material is made to simplify the discussion.

In a superconductor, if the current I is approximately equal to the critical current I_{c}, the resistance of the superconductor is non-zero, but small. However, if I is much larger than the critical current I_{c}, the resistance of the superconductor becomes sufficiently large to cause heat dissipation which can heat the superconductor to a temperature above its critical temperature, which in turn causes it to no longer be superconducting. This condition is sometimes referred to as a “quench” and can be damaging to the superconductor itself.

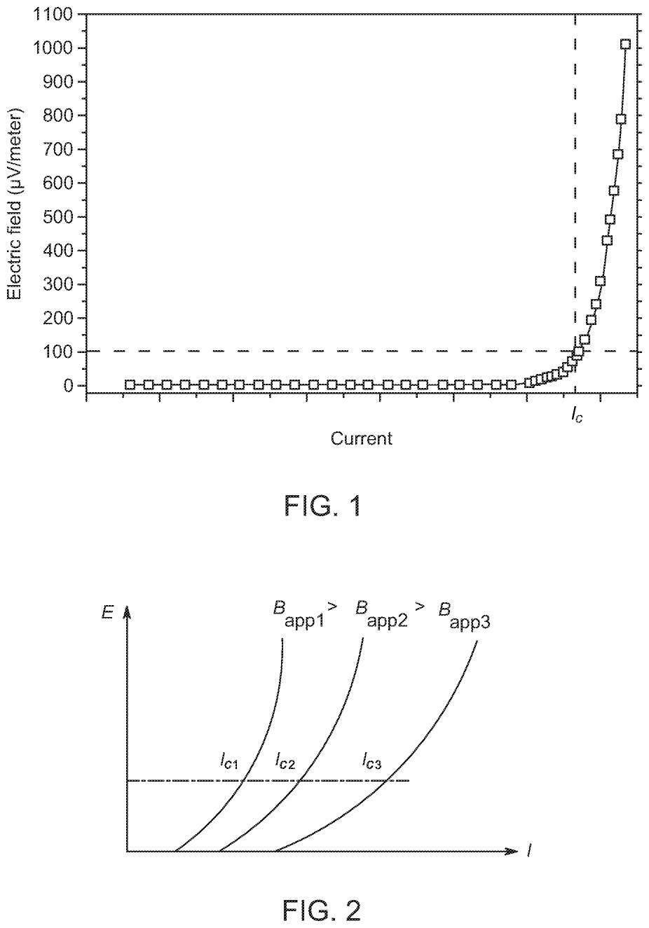

FIG. 1 shows an exemplary plot depicting the internal electric field versus current curve for a high-temperature superconductor. The electric field shown in this plot is related to resistance via the following equation:

$$E = \frac{IR}{L}$$

where:
E is the electric field;
I is the current through the superconductor;
R is the resistance of the wire; and
L is the length of the wire.

Accordingly, the plot of FIG. 1 is related to the resistance per-unit length for the superconductor and, because the curve depicted is non-linear, the resulting resistance for the superconductor is non-linear with current.

In FIG. 1 it can be seen that the electric field strength in the superconductor is substantially zero below the critical current I_{c} for the superconductor. As the current in the superconductor approaches the critical current, the electric-field in the superconductor starts to increase. At the critical current, the electric-field in the superconductor is 100 μV/m. Further increasing the current in the superconductor above the critical current results in rapid increases in the electric-field strength in the conductor.

The transition from the superconducting to the normal state in HTS materials, such as is shown in FIG. 1, can be described by an empirical law known as the E-J power law:

$$E = {{E}_{0} ( \frac{J}{{J}_{c}} )}^{n}$$

where E is the electric field in the conductor, J is the current density, and n is an experimentally defined unitless parameter which governs the steepness of the transition. In most superconductors, n has a value between 25-30. The critical current density J_{c} is defined by some arbitrarily chosen threshold field E₀, which may be 100 μV/m (=1 μV/cm) as explained above.

In this specification reference may be made to the relative resistances of a superconducting material and components comprising a superconducting material. More particularly, the specification refers to a superconducting material being in a low-resistance or higher-resistance state. It will be appreciated that, when in a superconducting state, superconducting materials can have a resistance which is zero or substantially zero, and as such these resistances are often expressed in terms of the electric field present across the superconducting material for a given current. Nevertheless, throughout the present specification, reference is made to relative resistances, for example low-resistance and higher-resistance states of the superconducting material, in order to simplify the discussion.

The term ‘low-resistance state’ may refer to when the superconducting material has a resistance that is close to or substantially zero in the superconducting state, or when the material has a low resistance in a partially superconducting state. The term ‘higher-resistance’ state refers to a state in which the superconducting material has a resistance that is substantially greater than the resistance in the low resistance state, for example a substantially non-zero resistance or a resistance that is close to zero but substantially greater than the resistance in the low-resistance state. For the avoidance of doubt, a higher-resistance state as referred to in this specification may, unless the context clearly indicates otherwise, include a superconducting state.

Similarly, where in this specification reference is made to a superconductor being in a higher-resistance state as a result of a current carried by the superconductor exceeding the critical current, it should be understood that, unless the context clearly indicates otherwise, the higher-resistance state may also be achieved if the current carried by the superconductor approaches or is substantially equal to the critical current.

In describing the technology in this specification, material and components comprising the material are referred to as “superconducting”. This term is commonly used in the art for such materials and should not be taken to mean that the relevant material is always in a superconducting state. Under certain conditions the material and components comprising the material may not be in a superconducting state. That is, the material may be described as being “superconductive”.

### 6.1.2. Superconducting Materials

Certain forms of the technology may involve components formed of type II superconductors, for example high-temperature superconducting (HTS) materials. Exemplary HTS materials suitable for use in the forms of technology described include copper-oxide superconductors, for example a rare-earth barium copper oxide (ReBCO) such as yttrium barium copper oxide, gadolinium barium copper oxide or bismuth strontium calcium copper oxide (BSCCO) superconductors, and iron-based superconductors. BSCCO superconductors typically have a strong interdependence between critical current and an applied magnetic field, which may make them particularly suitable for some forms of the present technology.

### 6.1.3. Superconducting Switches

Forms of the technology involve the use of superconducting switches. A superconducting switch is a switch formed from a length of superconducting material that can transition between a low-resistance state and a higher resistance state as described herein. These states are not open/closed circuit states as would be common for traditional normally conducting switches, and typically, even in the higher resistance state, the resistance may be considered to be low by the standards of a normally conducting switch, e.g. a few ohms or less. In certain forms, the length of superconducting material forming the switch may be in the superconducting state when in the higher resistance state.

When in a superconducting state, a superconducting material can have a resistance which is zero or substantially zero, and as such resistances in a superconducting state are more commonly expressed in terms of the electric field present across the superconducting material for a given current. Nevertheless, throughout the present specification, reference has been made to relative resistances, low-resistance and higher-resistance states in order to simplify the foregoing discussion.

This transition between the low and higher resistance states in a superconducting switch may be induced using thermal, self-field, or magnetic-field driven switching. Forms of the technology may use self-field and magnetic-field driven switching.

### 6.1.3.1. Self-Field Switching

In self-field switching, the length of superconducting material that forms the switch and the waveform of the applied current supplied to the length of superconducting material may be chosen such that, during a portion of the waveform, the current exceeds the critical current I_{c} in the switch. This causes the length of superconducting material to transition into a higher resistance state. In the other portions of the applied waveform, the generated current is below the critical current I_{c} such that the switch remains in a low-resistance state. This switching mechanism has been shown to produce the rectification needed for flux pumping.

While forms of the technology will be described below without using self-switching, it should be understood that other forms of the technology may use this method.

### 6.1.3.2. Magnetic-Field Switching

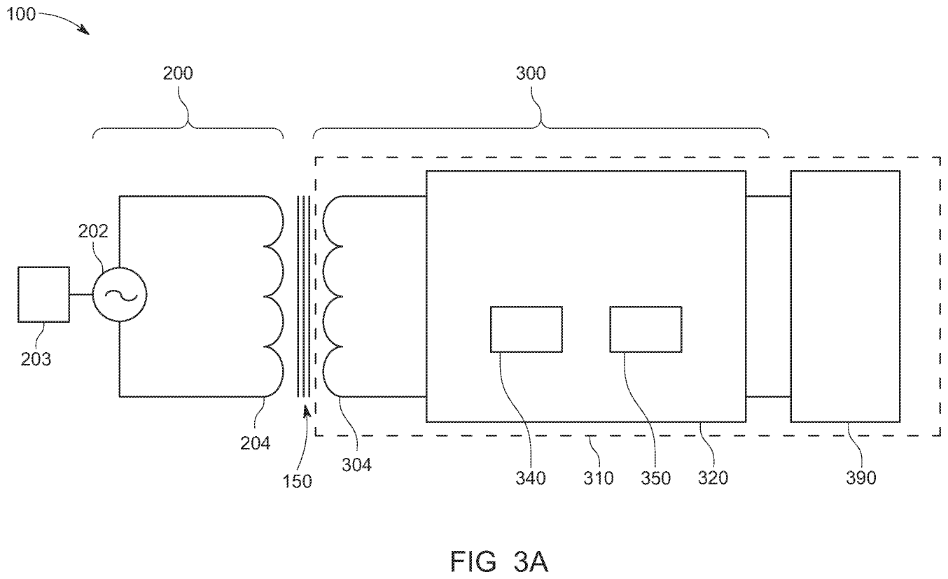

The critical current in a superconductor is dependent on the external magnetic field applied to the superconductor. More particularly, the critical current decreases as a higher external magnetic field is applied to the superconductor, up to the value of the critical field, above which the superconductor is no longer in the superconducting (low resistance) state. This relationship is shown in FIG. 2, which is an illustration of graphs of electric field against current for a superconducting material when three external magnetic fields of different magnitude are applied. The highest magnitude of external magnetic field, Bₐₚₚ₁, results in the lowest critical current, I_{c1}. In some forms, the external magnetic field to achieve this effect may be applied perpendicular to the surface of the length of superconductor in which the critical current is reduced, or suppressed. The applied magnetic field may be in one direction only, which may be referred to as a DC field, as compared to a time-varying magnetic field whose direction cycles, for example sinusoidally, which may be referred to as an AC field.

For all superconductors, the critical current drops off sharply with only a small applied magnetic field. This means that a small change in the applied magnetic field can result in a large change in the critical current. This relationship is dependent on the superconducting material and the way the length of superconducting material that carries current was manufactured.

It should be appreciated that this mechanism to reduce or suppress the critical current by applying an external magnetic field, e.g. a DC field, is different from the phenomenon of dynamic resistance. This occurs when a superconductor is exposed to a time-varying, e.g. AC, magnetic field while carrying a DC transport current. This creates a DC electrical resistance in the superconductor, which may be sufficiently large that the superconductor switches into a higher-resistance state.

While forms of the technology will be described in relation to DC applied magnetic field, it should be understood that other forms of the technology may use other types of critical current suppression, for example dynamic resistance, in their place.

### 6.2. Transformer-Rectifier Flux Pump

Certain forms of the technology relate to flux pumps and, in particular, transformer-rectifier flux pumps (TRFPs). Certain exemplary forms of TRFP will be described in detail in the following passages but it should be understood that forms of the technology are not limited to the concepts described as being used or applicable to these forms of TRFP and other forms of TRFP may be used in other forms of the technology.

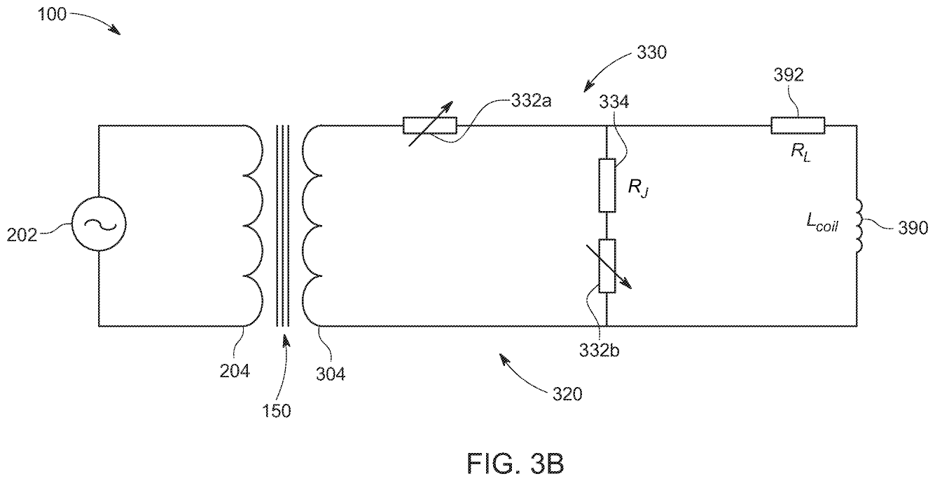

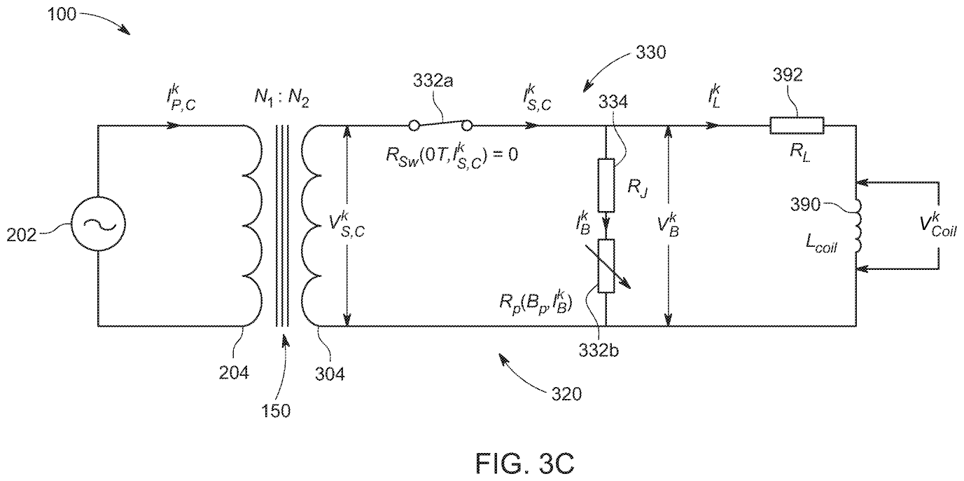

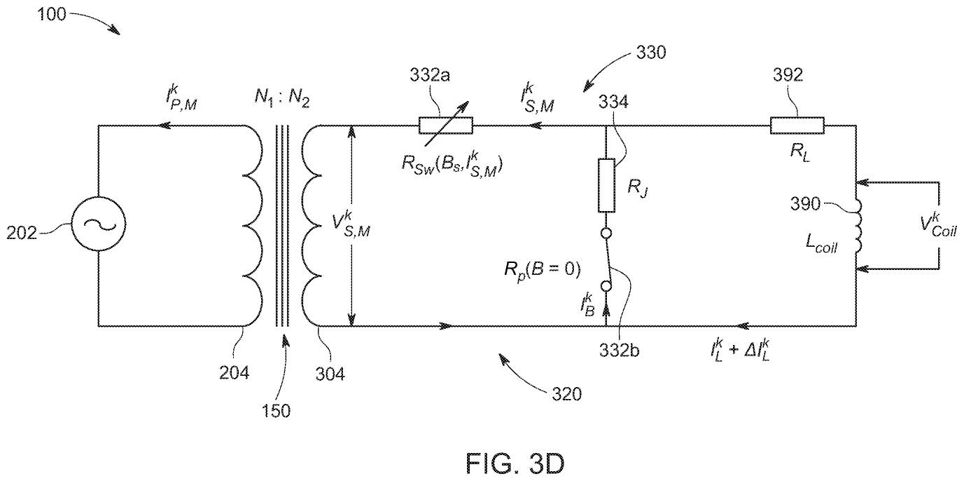

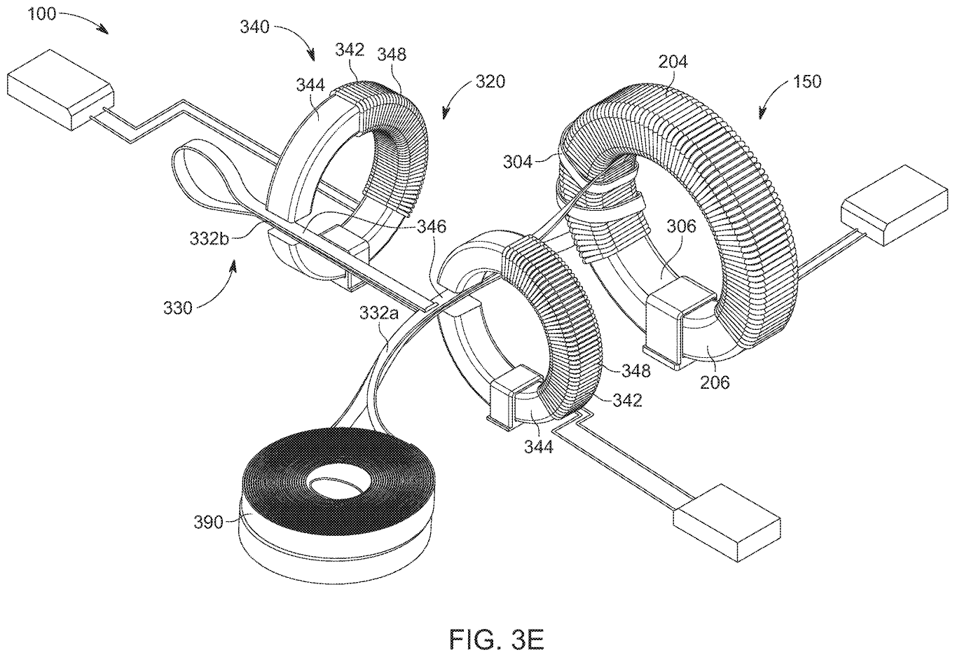

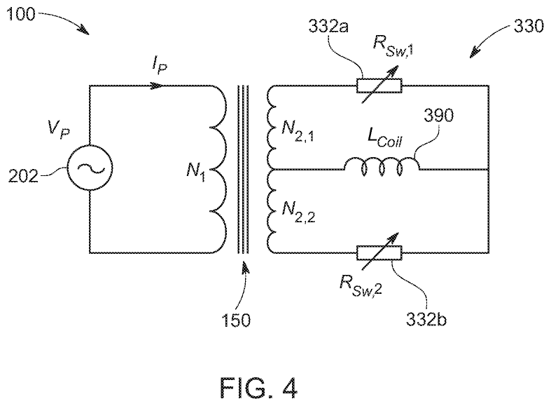

FIG. 3A is a schematic diagram of a flux pump 100 according to certain forms of the technology, which in the example shown is a TRFP 100. FIGS. 3B-3D are circuit diagrams of an example of such a flux pump 100 according to certain forms, and FIG. 3E is an illustration of one form of TRFP 100 whose circuit diagram is shown in FIGS. 3B-3D. For clarity, not all components are shown on all of these diagrams.

The TRFP 100 comprises a primary side 200 and a secondary side 300, as will be described in more detail below. In use, the primary side 100 of TRFP 100 is supplied with an alternating primary current I_{P} and the TRFP 100 operates to supply a rectified, i.e. direct, load current I_{L} to a load 390. Over multiple cycles of the primary current I_{P}, the load current I_{L} increases as more current is “pumped” into the load 390 each cycle by the flow of flux through the TRFP 100.

### 6.2.1. Primary Side

The primary side 200 of the TRFP 100 comprises a primary coil 204 configured to receive a primary current I_{P} from a current source 202. In certain forms, the TRFP 100 may also comprise the current source 202. In certain forms, the primary side 200 comprises components formed from conventional (non-superconducting) conductors. The primary coil 204 may comprise one or more turns of a conductor. A length of conductor may transport the primary current I_{P} to the primary coil 204.

The primary side 200 may comprise a primary magnetic core 206 formed from a material having a relatively high magnetically permeability, for example ferrite. The primary coil 204 may be wound around part of the primary magnetic core 206.

The current source 202 may be configured to supply a current to the primary coil 204 that has selected characteristics. A further explanation of these characteristics is provided below. The current I_{P} provided by the current source 202 may be controlled by a current control mechanism 203. Any suitable form of current control mechanism 203 may be used, for example a processor operatively connected to the current source 202. In certain forms, the TRFP 100 may also comprise the current control mechanism 203.

### 6.2.2. Secondary Side

In certain forms of the technology, the secondary side 300 of the TRFP 100 comprises a secondary coil 304 and a rectifier 320. The secondary side 300 may be configured to deliver a load current I_{L} to a load 390. The secondary side 300 of the TRFP 100 and the load 390 may be housed in a cryostat 310. Generally speaking, the electrically conductive components of the secondary side 300 of the TRFP 100 may be formed from one or more superconducting materials.

### 6.2.2.1. Cryostat

In the forms illustrated in FIGS. 3A to 3E, the TRFP 100 may comprise a cryostat 310 to house the components of the secondary side 300 and to maintain a temperature suitable for the superconducting components to adopt a low resistance, or superconducting, state (absent other factors that may result in one or more of the superconducting components adopting a higher resistance, or non-superconducting, state, for example a current exceeding the critical current of the superconducting material or a magnetic field exceeding the critical field of the superconducting material). For example, the cryostat 310 may maintain the secondary side 300 at a temperature that is less than the critical temperature T_{C} of the superconducting materials in the secondary side 300. Any suitable form of cryostat or cooling mechanism may be used. In some forms, some or all of the components of the primary side 200 may be positioned inside the cryostat 310. The cryostat is not shown in FIGS. 3B to 3E.

### 6.2.2.2. Secondary Coil

The secondary side 300 of the TRFP 100 comprises a secondary coil 304. The secondary coil 304 may comprise one or more turns of a superconductor, for example a HTS material. The secondary side 300 may comprise a secondary magnetic core 306 formed from a material having a relatively high magnetically permeability, for example ferrite. The secondary coil 304 may be wound around part of the secondary magnetic core 306.

In certain forms of the technology, the TRFP 100 may comprise a transformer 150. The transformer 150 may comprise the primary coil 204 and the secondary coil 304. The transformer 150 may comprise a magnetic core formed from the primary magnetic core 206 and the secondary magnetic core 306. The primary magnetic core 206 and the secondary magnetic core 306 may be magnetically coupled together to form a magnetic circuit. In some forms the primary magnetic core 206 and the secondary magnetic core 306 may be integral parts of the same body of magnetically permeable material. In other forms, the primary magnetic core 206 and the secondary magnetic core 306 may be physically and thermally separated, for example the secondary magnetic core 306 may be placed inside the cryostat 310 and the primary magnetic core 206 may be placed outside the cryostat 310, but relatively placed so as to be magnetically coupled when carrying a magnetic field.

In operation, when a time-varying (e.g. alternating) current I_{P} is supplied to the primary coil 204, a time-varying (e.g. alternating) current I_{S} is induced in the secondary coil 304.

A TRFP 100 comprising a transformer 150 according to certain forms of the technology may be suitable for use in various applications, including superconducting magnets, superconducting motors/generators, space propulsion systems, fusion reactors, research magnets, NMR, MRI, levitation, water purification and induction heating, for example. The use of a transformer 150 in a TRFP enables two parts of the TRFP to be electrically separated. A suitable form of TRFP for the application will depend on a variety of factors including physical size constraints, cryogenic heat loads, output power, efficiency, cost and controllability.

### 6.2.2.3. Rectifier

In certain forms of the technology, the secondary side 300 of the TRFP 100 comprises a rectifier 320 to rectify the alternating current I_{S} induced in the secondary coil 304 into a direct load current I_{L} for supply to the load 390. Exemplary forms of rectifier 320 are illustrated in FIGS. 3B-3E, and will be described in detail below, but the rectifier 320 may comprise other arrangements of components in other forms of the technology.

A rectifier 320 according to forms of the technology may comprise the following functional parts: a switching assembly 330; a magnetic field generator assembly 340; and a control mechanism 350. These functional parts will be described in more detail below, with descriptions of exemplary forms of each functional part. A specific example of a rectifier 320 comprising an exemplary form of each functional part will also be described. It should be understood that other combinations of exemplary forms of each functional part are also provided in some forms of the technology, and the technology is not limited to the specific examples illustrated and/or described.

In certain forms, the secondary coil 304 supplies the alternating current I_{S} to the switching assembly 330. The switching assembly 330 comprises an arrangement of one or more electrical switches 332 and is configured to rectify the alternating current to produce the direct load current I_{L} for supply to the load 390. The magnetic field generator assembly 340 comprises one or more magnetic field generators 342, each configured to apply a magnetic field to one or more of the electrical switches 332. The control mechanism 350 controls the magnetic field generator assembly 342 in order to switch the electrical switches 332 of the switching assembly 330. The magnetic field generator assembly 340 and control mechanism 350 are not shown in the circuit diagrams of FIGS. 3B to 3D.

### 6.2.2.3.1. Switching Assembly

In certain forms of the technology, the switching assembly 330 comprises an arrangement of one or more electrical switches 332 and is configured to rectify the alternating current to produce a direct current output, for example load current I_{L} for supply to the load 390. The arrangement of the electrical switches 332 in the switching assembly 330 determines the type of rectification performed by rectifier 320, as will be described below. Different forms of the technology may utilise one or more electrical switches 332 in any configuration in order to produce a rectifying effect. In the following description, examples of suitable configurations of electrical switches are described, although it should be understood that other configurations may be used in other forms of the technology.

In certain forms of the technology, for example as shown in FIGS. 3B to 3E, the rectifier 320 is a half-wave rectifier. In the form shown in FIGS. 3B to 3E, the switching assembly comprises two superconducting switches 332a and 332b. The two switches 332a and 332b are connected in series and a load 390 is connected in parallel across one of the switches 332b. The length of superconducting material across which the load 390 is connected may be referred to as the “bridge” and the switch 332b may be referred to as a bridge switch. The other switch may be referred to as the series switch 332a.

In the form shown in FIGS. 3B to 3D, it is assumed that a joint having non-zero resistance R_{J} is used to connect the length of superconducting material that forms electrical switch 332b in parallel between the lengths of superconducting material that connect to the secondary coil 304. In addition, the joints that connect the rectifier 320 to the load 390 are assumed to have non-zero resistance R_{L}. For example, the respective joints could be solder joints. In order to model the resulting behaviour of the circuit, as explained later, the joints connecting the bridge to the length of superconducting material connecting to the secondary coil 304 are shown as resistor 334 and the joints connecting the load 390 to the rectifier 320 are shown as resistor 392.

An alternating current I_{S} is provided to the switching assembly 330 from the secondary coil 304. The switching assembly 330 is controlled by a control mechanism 350 configured to control the state of each of the switches 332 in order to rectify the alternating current I_{S}. For example, the control mechanism 350 controls each of the switches 332 so that the state of each switch is based on the direction of flow of the alternating current I_{S}. Since the direction of flow of the alternating current I_{S} depends on the phase of the current, in this form the control mechanism 350 controls the state of each of the switches 332 in a timed manner based on a phase of the alternating current I_{S}. For example, when the alternating current I_{S} is flowing in a first direction (i.e. the current flow is positive) the first switch 332a is placed in its low-resistance state and the second switch 332b is placed in its higher-resistance state. As such, a low resistance path is formed around the outside of the loop through switch 332a and across the load 390. This is the configuration of the rectifier 320 shown in FIG. 3C, in which switch 332a is depicted as a closed switch and switch 332b is depicted as a variable resistor, and may be referred to as the “charging phase”, as current I_{L} is supplied to the load 390 in this phase of the cycle.

As the polarity of the current changes (for example from positive to negative), the control mechanism 350 may cause switch 332a to transition into its high-resistance state, and switch 332b to transition to a low-resistance state. The higher-resistance state of 332a impedes the current flow from the transformer, providing a measure of blocking to the negative polarity current flow. Simultaneously, the low-resistance state of 332b provides a path for the current flow in the load to continue, albeit while exponentially decaying with a time constant L/R (which will mean that the load current will remain constant if the complete load loop is superconducting). This is the configuration of the rectifier 320 shown in FIG. 3D, in which switch 332a is depicted as a variable resistor and switch 332b is depicted as a closed switch, and may be referred to as the “maintenance phase”, as the current in the load 390 in this phase of the cycle is generally maintained. Accordingly, the current flow through the load 390 may be half-wave rectified. Again, the control mechanism 350 may open and close switches 332a and 332b (i.e. increase and decrease the resistance of switches 332a and 332b) at appropriate times to increase and decrease the current in the load 390 as desired.

In some forms of the technology, the control mechanism 350 may control both switch 332a and switch 332b to be simultaneously in the low-resistance state for some period of time in the alternating current cycle. That is to say that switch 332b may be in a higher-resistance state for only a portion of the time that I_{S} is positive, and switch 332a may be in a higher-resistance state for only a portion of the time that I_{S} is negative and, for the rest of time, both switches are in a low-resistance state, whether I_{S} is positive or negative. This may be used as a practical control strategy to ensure that a switch is in the open configuration (i.e. the higher-resistance state) when the current through it is in the desired direction. The control mechanism 350 may control the switches of the rectifiers of any of the forms of technology described herein in this way, even if not expressly stated. In some forms, the control mechanism 350 may control switches 332a and 332b in this way in the persistent mode, described further below.

While FIGS. 3B to 3E illustrate an exemplary arrangement of two switches 332 in a switching assembly 330 forming a half-wave rectifier, it should be understood that other switching assemblies 330 in other forms of the technology have other arrangements of switches 332 for rectifying an alternating current. In addition, switching assemblies 330 of other forms of the technology may have other numbers of switches 332. For example, in some forms of the technology in which the rectifier 320 acts as a half-wave rectifier, the switching assembly 330 may comprise a single superconducting switch 332.

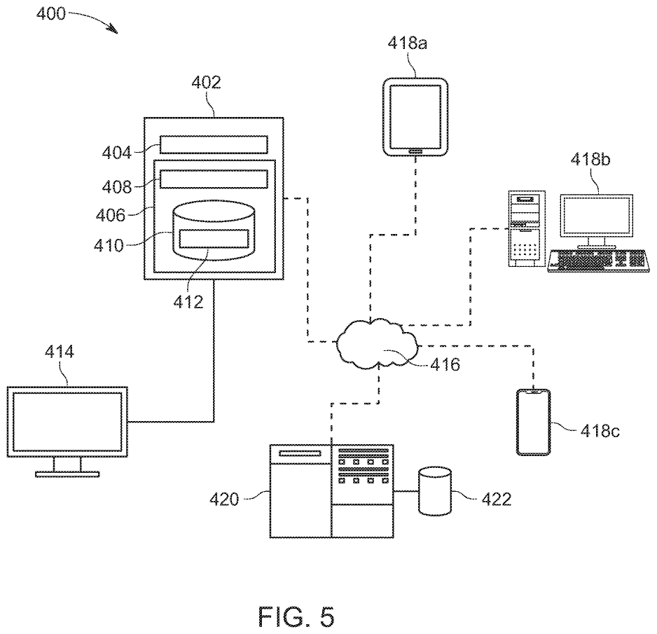

In addition, in some forms of the technology, the rectifier may act as a full-wave rectifier. In some such forms, the rectifier may comprise a switching assembly 330 comprising an arrangement of two switches 332. In other forms, the rectifier may comprise a switching assembly 330 comprising an arrangement of four switches 332. An exemplary form of a centre-tapped full-wave transformer-rectifier is displayed in FIG. 4.

Suitable arrangements of switches 332 in switching assemblies 330 comprised as part of a rectifier 320 are described in more detail in PCT Application No. PCT/NZ2022/050009, published as International Publication No. WO 2022/164330, the contents of which are herein incorporated by reference.

### 6.2.2.3.2. Switch

Forms of the technology involve the use of one or more superconducting switches 332 that utilise the principle that the critical current of a superconducting material decreases as a higher external magnetic field is applied to the material, i.e. magnetic-field switching as explained earlier. Exemplary such electrical switches 332a and 332b are illustrated in FIGS. 3A to 3E. For reasons that will become apparent, switches 332a and 332b are shown as variable resistors in FIG. 3B.

Electrical switch 332 comprises a length of high temperature superconducting (HTS) material, for example any of the types of HTS material described above. The HTS material has a critical current I_{c} and a critical temperature T_{c}. The HTS material is positioned inside a cryostat 310 configured to maintain the HTS material at a temperature that is less than the critical temperature T_{c}.

When an external magnetic field Bₐₚₚ is applied to the length of HTS material the critical current reduces, as shown in FIG. 2. The application of the magnetic field Bₐₚₚ can therefore be used to cause the length of HTS material to act as a switch. If the HTS material carries a switch current (i.e. a current flowing through the electrical switch 332) that is less than the critical current when the magnitude of the magnetic field Bₐₚₚ has a certain value then the HTS material will be in a low-resistance state. If the magnitude of the magnetic field Bₐₚₚ is increased from that value to a relatively high magnitude that is sufficiently high that the critical current reduces to a value that is closer to, or below, the magnitude of the current carried by the HTS material, then the HTS material will be in a higher-resistance state.

The low-resistance state of the HTS material can be considered equivalent to the closed state of switch 332 while the higher-resistance state is similar to an open state of switch 332. It should be appreciated, however, that the higher-resistance state is not an electrical open-circuit as would be common for a mechanical switch, but rather represents a higher-resistance conductive state. In this higher-resistance conductive state, the HTS material may remain in the superconducting state but with a higher level of resistance, or it may be in a non-superconducting state.

The difference in magnitude of the magnetic field Bₐₚₚ between the low-resistance state and higher-resistance state of the switch may be varied to a plurality of magnitudes, including a continuously variable magnitude and including varying it between two magnitudes. In the low-resistance state the magnitude of the magnetic field Bₐₚₚ may be zero or non-zero.

It will be appreciated that, in some forms, any magnitude of the magnetic field Bₐₚₚ applied to the HTS material may be below the magnitude of the critical field, where the critical field is the magnitude of the external magnetic field applied to the HTS material that causes the HTS material to move into the higher-resistance state.

The energy loss in a superconducting switch is related to the critical current in the switch during switching. Since the electrical switch 332 operates by reducing the value of the critical current during switching, the electrical switch 332 (and devices comprising the electrical switch 332) have lower losses and therefore higher efficiencies than conventional superconducting switches.

In other forms of the technology, the switching assembly 330 of the rectifier 320 may comprise one or more switches 332 that operate on one or more different principles. Examples of alternative principles upon which a switch 332 may work in other forms are described in more detail in PCT Application No. PCT/NZ2022/050008, published as International Publication No. WO 2022/164329, the contents of which are herein by reference. In certain forms, the switching assembly 330 may comprise a plurality of switches 332 operating on any combination of one or more of the principles described above.

In some forms, one or more of the switches 332 may operate on the principle of self-field switching, as explained earlier. In some forms, one or more of the switches 332 may operate on the principle of dynamic resistance. This occurs when a superconductor is exposed to a time-varying magnetic field while carrying a DC transport current. This creates a DC electrical resistance in the superconductor, which may be sufficiently large that the superconductor switches into a higher-resistance state. The time-varying magnetic field that causes the dynamic resistance phenomenon may be an alternating magnetic field, for example a magnetic field varying sinusoidally. In the case of a superconducting material having a length significantly larger than its width or depth (e.g. a wire or tape), dynamic resistance may be mainly caused by the component of the time-varying magnetic field that is applied to the superconducting material that is perpendicular to the direction along the length of the material.

### 6.2.2.3.3. Magnetic Field Generator Assembly

In certain forms of the technology, the magnetic field generator assembly 340 comprises one or more magnetic field generators 342, each of the magnetic field generators 342 being configured to apply a magnetic field to one or more of the electrical switches 332 of the switching assembly 330, and in particular one or more lengths of superconducting material comprising each electrical switch 332.

Exemplary forms of magnetic field generator assemblies 340 are illustrated in FIGS. 3A to 3E. In these forms, the magnetic generator assembly 340 comprises one or more magnetic field generators 342. Each of the magnetic field generators 342 may comprise a magnetic core 344. The core 344 may be a high-permeability magnetic core such as a ferrite core (e.g. an iron core) or a laminated steel/iron core. In other forms, other types of high relative permeability at the operating frequency may also be used, or a non-magnetic core or air core may be used. Air cores may advantageously reduce the size, weight and cost of the electrical switch 332 and may also provide the ability to drive higher currents without saturating the core. In the illustrated forms the magnetic core 344 is a substantially ring-shaped solid core, for example a square-shaped ring having rounded corners.

In the exemplary forms, the magnetic core 344 forms a gap 346. The gap 346 may be a space in a solid magnetic core 344, for example a space in one side of a square-shaped ring core. Any part of an air core may be considered to be a gap 346.

In the exemplary forms, a conductor is wound around a part of the magnetic core 344 in a coil 348. For example, the coil 348 formed by the conductor may be wound around a side of a square-shaped ring core, for example the side opposite the side on which the gap 346 is formed. In an air core, the coil 348 defines inside it a region of space, and that region of space may be considered to be the air core and to contain the gap 346. In use, the conductor may carry an applied current, which may be referred to as a generator current. The flow of the generator current through the coil 348 generates a magnetic field, including in core 344 and across gap 346. In certain forms of the technology, the length of HTS material comprising an electrical switch 332 is positioned in the gap 346 such that the magnetic field generated by the magnetic field generator 342 across gap 346 is an external magnetic field Bₐₚₚ applied to the switch 332.

In certain forms, the generator current carried by the conductor may be supplied by a current source, for example an alternating current source so that that generator current is an alternating generator current. In certain forms, the current source may be any of the current sources described in PCT Application No. PCT/NZ2022/050009, published as International Publication No. WO 2022/164330, the contents of which are herein incorporated by reference. The generator current may be controlled by a current control mechanism, for example the control mechanism 350 described below.

The magnitude of the magnetic field generated by the magnetic field generator(s) 342 may be continuously varying. Alternatively, the magnitude of the magnetic field generated by the magnetic field generator(s) 310 may vary between two constant values. In certain forms, one of the constant values may be zero.

One example of a TRFP 100 according to a form of the technology is illustrated in FIG. 3E. In FIG. 3E, the cryostat 310 is not shown, although it should be understood that all the superconducting components are housed in a cryostat 310. In one form of such a TRFP 100, the magnetic cores of each of a transformer 150 and first and second magnetic field generators 342 are split into two core parts, with each magnetic core having one of the core parts located inside a cryostat 310 and the other core part located outside the cryostat 310, for example the secondary magnetic core 306 of the transformer 150 is positioned inside the cryostat 310 and the primary magnetic core 206 is positioned outside the cryostat 310. The two parts of each magnetic core are magnetically coupled together. The inside of the cryostat 310 is maintained at a temperature sufficiently low to enable the lengths of the superconducting material positioned inside the cryostat 310, including those forming electrical switches 332, to operate in the low-resistance, or superconducting, state.

In another form of such a TRFP 100, all of the magnetic cores 344, 206 and 306 of the magnetic field generators 342 and the transformer 150 are located inside the cryostat 310. The magnetic cores of each of the transformer 150 and first and second magnetic field generators 342 and 310 are split into two core parts, with the two core parts in each magnetic core being separated by a thermal break. The two parts of each magnetic core are magnetically coupled together. Conductors connecting to the primary coil 204 of the transformer and to the coils 348 of the magnetic field generators 342 pass through the walls of the cryostat 310.

While certain exemplary arrangements of magnetic field generators 300 in a magnetic field generator assembly 340 have been described, it should be understood that other magnetic field generators 342 in other forms of the technology may take other forms, for example as described in PCT Application No. PCT/NZ2022/050009, published as International Publication No. WO 2022/164330, the contents of which are herein incorporated by reference.

### 6.2.2.3.4. Control Mechanism

Rectifiers 320 according to certain forms of the technology comprise a control mechanism 350 configured to control the magnetic field generator assembly 340 in order to switch the electrical switches 332 of the switching assembly 330.

In certain forms of the technology, the control mechanism 350 is configured to control the magnetic field generator(s) 342 of the magnetic field generator assembly 340 such that the magnitude of the magnetic field generated by each magnetic field generator 342 is based on a phase of the current I_{P} in the primary coil 204. For example, the magnitude of the magnetic field generated by each magnetic field generator 342 may vary with a phase that is a fixed phase difference from a phase of the primary current I_{P}. In one example, the fixed phase difference may be zero, in which case the magnetic field generated by each magnetic field generator 342 varies in phase with the primary current I_{P}. In certain examples, the magnitude of the magnetic field generated by each magnetic field generator 342 may be a first value for a part of each cycle of the primary current I_{P}, and a second value for another part of each cycle of the primary current I_{P}. One of the first or second values may be zero.

In other forms of the technology, the rectifier 320 may comprise a control mechanism 350 as described in PCT Application No. PCT/NZ2022/050009, published as International Publication No. WO 2022/164330, the contents of which are herein incorporated by reference.

### 6.2.2.4. Load

A load 390 is connected to rectifier 320 and the rectifier supplies a direct load current I_{L} to the load 390. In some forms, the load 390 may be considered to be part of the TRFP 100, i.e. part of the secondary side 300, while in other forms, the load 390 may be considered to be separate to the TRFP 100 and the TRFP 100 be configured to supply the load current to the load 390.

Forms of the technology may not be limited by the nature of the load 390. However, in some examples, the load 390 may comprise a HTS magnet, which may comprise a coil of superconducting material and a core. Typical examples of load 390 may have a significant inductance. In forms of the technology shown in FIGS. 3B to 3D, the load 390 is represented as an inductor with inductance L_{coil}.

### 6.3. Current Source & Current Control Mechanism

It has been explained that the current source 202 may be configured to supply an applied current I_{P} to the primary coil 204 that has selected characteristics, and the current, may be controlled by a current control mechanism 203. Although certain aspects of the technology are related to the manner in which the current supplied to the primary coil 204 is controlled, as will be explained further below, in certain forms, the technology is not limited by the type of the apparatus and system used to supply current to the primary coil 204, and any suitable form of current source 202 and current control mechanism 203 may be used. Certain aspects of the technology are related to the manner in which current supplied to the magnetic field generator assembly 340 is controlled and, again, the technology is not limited by the type of the apparatus and system used to supply current to the magnetic field generator assembly 340, and any suitable form of current source and control mechanism 350 may be used.

In certain forms, the current control mechanism 203 may comprise a waveform generator, for example an arbitrary waveform generator (AWG) or function generator. In certain forms, the waveform generator may be implemented through an apparatus whose operation is dedicated to the function of waveform generation. In certain forms, the waveform generator may comprise any processing system or computing device configured to run waveform generator software, including devices not dedicated to this purpose, e.g. general-purpose computing or processing devices.

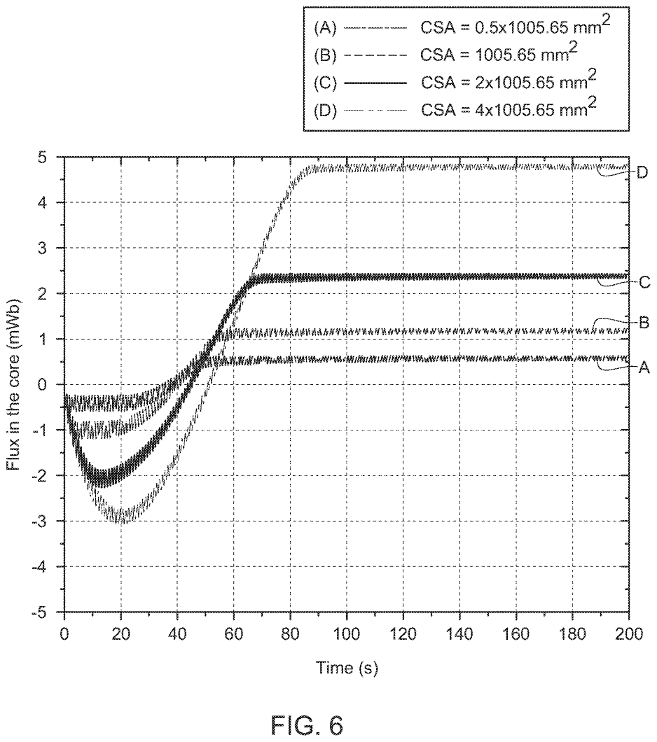

FIG. 5 is a schematic illustration of an exemplary processing system 400 according to one form of the technology. In certain forms, the current control mechanism 203 may comprise processing system 400, which is configured to operate as a waveform generator.

Processing system 400 comprises a hardware platform 402 that manages the collection and processing of data from one or more devices, which may include sensors and user devices. The hardware platform 402 has a processor 404, memory 406, and other components typically present in such computing devices. The hardware platform 402 may be local to the device(s) or it may be remote from the device(s) and receive the data over a suitable communications link. In the exemplary form of the technology illustrated, the memory 406 stores information accessible by processor 404, the information including instructions 408 that may be executed by the processor 404 and data 410 that may be retrieved, manipulated, or stored by the processor 404. The memory 406 may be of any suitable means known in the art, capable of storing information in a manner accessible by the processor 404, including a computer-readable medium, or other medium that stores data that may be read with the aid of an electronic device.

The processor 404 may be any suitable device known to a person skilled in the art. Although the processor 404 and memory 406 are illustrated as being within a single unit, it should be appreciated that this is not intended to be limiting, and that the functionality of each as herein described may be performed by multiple processors and memories, that may or may not be remote from each other or from the processing system 400. The instructions 408 may include any set of instructions suitable for execution by the processor 404. For example, the instructions 408 may be stored as computer code on the computer-readable medium. The instructions may be stored in any suitable computer language or format. Data 410 may be retrieved, stored or modified by processor 404 in accordance with the instructions 410. The data 410 may also be formatted in any suitable computer readable format. Again, while the data is illustrated as being contained at a single location, it should be appreciated that this is not intended to be limiting—the data may be stored in multiple memories or locations. The data 410 may also include a record 412 of control routines for aspects of the system 400.

The hardware platform 402 may communicate with a display device 414 to display the results of processing of the data. The hardware platform 402 may communicate over a network 416 with one or more other devices (for example user devices, such as a tablet computer 418a, a personal computer 418b, or a smartphone 418c, or other devices including sensors, such as current sensors and voltage sensors, and current source 202), or one or more server devices 320 having associated memory 322 for the storage and processing of data collected by the local hardware platform 402. It should be appreciated that the server 320 and memory 322 may take any suitable form known in the art, for example a “cloud-based” distributed server architecture. The network 416 may comprise various configurations and protocols including the Internet, intranets, virtual private networks, wide area networks, local networks, private networks using communication protocols proprietary to one or more companies, whether wired or wireless, or a combination thereof.

The hardware platform 402 may be configured to run software configured to enable an inputter to input a desired waveform for the current I_{P} to be supplied by the current source 202 to the primary coil 204. The inputter may be a user who may interact with the software through any one or more user devices, for example display device 414 and/or personal computer 418b. The hardware platform 402 may be configured to run any conventional waveform generator software, as known in the art, for example. The software run by the hardware platform 402 may also be configured to enable a waveform for the current I_{P} to be determined by the hardware platform 402 itself, for example by the processor 404, which may be configured to run one or more algorithms for determining a desired current waveform, such as is described further below. In such forms, the inputter may comprise the hardware platform 402, for example the processor 404.

The hardware platform 402 may be configured to communicate with the current source 202 and to control the current source 202 to deliver current I_{P} to the primary coil 204 in accordance with the desired waveform selected by the user and/or processor 404, and in particular the waveform of the current I_{P}, i.e. how the current I_{P} varies with time. Hardware platform 402 may communicate with the current source 202 through a wired and/or wireless communication link in order to control the current source 202.

In certain forms, the TRFP 100 comprises the current source 202 and current control mechanism 203. In other forms, the current source 202 and current control mechanism 203 are separate to the TRFP 100 and the current source 202 is configured to supply current to the TRFP 100.

### 6.4. Control of Primary Current Supplied to TRFP

As explained earlier, the current source 202 of the primary side 200 may be configured to supply an applied current I_{P} to the primary coil 204 that has selected characteristics in order to charge the load 390 in a desired manner. In certain forms of the technology, these characteristics are determined based on the load current that is to be supplied to be the load 390 at the end of the load charging process and also the rate of increase of the load current that is required.

### 6.4.1. Development on Prior Research

Prior research into superconductor TRFPs has concentrated on demonstrating their principle of operation in a laboratory setting and there has been little research on how TRFPs operate in real-world applications. For example, in laboratory experiments, TRFPs are used to charge a load 390 comprising a relatively small load coil, e.g. a load coil with a relatively small inductance. In some real-world applications of superconductor TRFPs, load coils having significantly higher inductance may be used. HTS magnets for many applications may have inductances in the hundreds of mH or greater, in contrast to the few mH range contemplated within much of the existing literature. The inductance of the load coil is a key parameter in defining the charging rate of the TRFP, with another being the voltage generated across the load coil during each cycle. The rate of charging is inversely proportional to the load coil inductance meaning that, as the inductance increases, the number of charging cycles to reach a defined current increases proportionally. Therefore, TRFPs with load coils having inductances in the hundreds of mH may require the TRFP to operate over thousands of cycles to generate the same current as a TRFP with a load coil with an inductance of a few mH, as is typically discussed in the existing literature. In addition, load coils in real applications may require load currents greater than approximately 10 kA, while conventional TRFPs typically achieve values in the 2-3 kA range using a 10 μH load coil. Combining these two effects, for a TRFP with an equivalent voltage output, 10,000 more cycles may be required to achieve the same output current in a 100 mH load coil.

In developing certain forms of the technology described in this specification, it was considered how TRFPs operate when used with parameters that are likely to be used in some real-world applications of the technology. In doing so, certain improvements as to how TRFPs may be operated have been identified.

It should be understood that, unless specifically noted, the principles of operation of TRFPs described in this document are not limited in their application to situations in which the parameters of the system are as described above. That is, certain forms of the technology may be applied to any form of TRFP, irrespective of their size, parameters and application.

### 6.4.2. Net Voltage in the Secondary

Prior research has concluded that it is desirable to control the alternating applied current I_{P} being supplied to the primary coil 204 in such a way that there is a net zero current when integrated over a current cycle. However, it has been identified that, in some situations, for example when a TRFP is used to charge a load coil having a relatively high inductance, problems may occur with this approach, for example inconsistent charging and/or an inability to charge to the required current level. This issue will be briefly explained by discussing the mechanisms effecting rectification in a TRFP.

In the example of the TRFP 100 shown in FIGS. 3A-3E, the rectification of the alternating primary current I_{P} is determined by the voltage V_{B} generated across the bridge switch 332b. This voltage is determined by two factors: the critical current I_{C} of the length of superconducting material in the bridge switch 332b at the applied magnetic field and temperature and the current I_{B} flowing through this switch. In TRFP 100, rectification is achieved by controlling the currents I_{C} and I_{B} over time to create the desired voltage V_{B} that is output to the load 390. Some existing studies have not considered the dynamic nature of I_{B} through the charging process. In fact, two factors influence the change in I_{B} over time: 1) the absolute magnitude of the secondary current I_{S} induced in the secondary coil 304; and 2) the distribution of the secondary current I_{S} around the secondary side 300 of the TRFP 100.

In the case of a TRFP 100 comprising a rectifier 320 in the form of a half-wave rectifier, if the alternating primary current I_{P} has a constant waveform over every cycle (as is the case for conventional HTS flux pumps), the secondary current I_{S} in the secondary coil 304 will remain consistent throughout charging if the core of transformer 150 does not saturate during operation and/or if no DC offset is generated during the charging. In both cases, this manifests itself as changes in the power transfer behaviour of the applied waveform of the primary current I_{P} to the generated secondary current I_{S} throughout charging. In existing HTS TRFPs, a DC offset is observed and therefore the secondary current I_{S} changes throughout the charging cycle. As the secondary current I_{S} changes, the voltage V_{B} changes in conjunction, which alters and limits the charging rate.

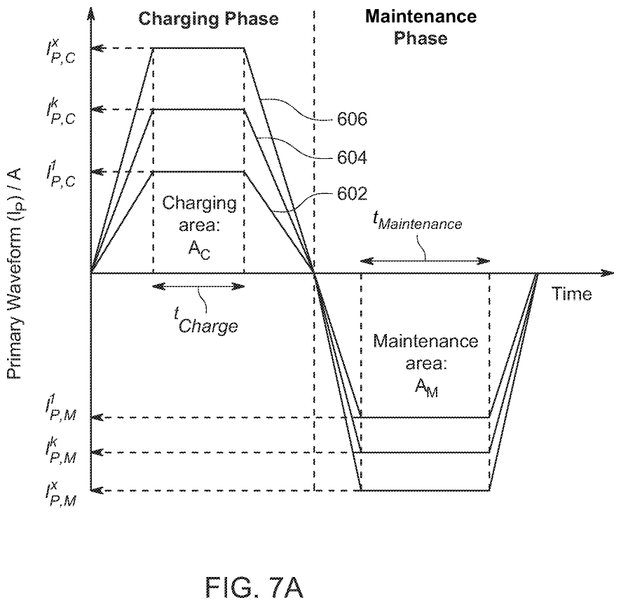

The transformer 150 may not saturate initially for a well-chosen transformer with a peak primary current I_{P} matched to its dimensions. However, it may saturate if the primary waveform does not have suitable characteristics. Simulations of saturation of a transformer 150 are shown in FIG. 6. This behaviour matches experimentally measured changes. It can be observed that the flux in the core changes significantly over time both in terms of magnitude and direction due to the dynamic nature of the flux pump behaviour. The effect of this variation in flux is to inherently alter the absolute magnitude of the secondary current I_{S}. For any DC offset, the absolute value of the secondary current I_{S} is shifted which will create variations in the charging profile of the load 390.

Having considered the factor 1), as above, we now discuss factor 2): the distribution of secondary current I_{S} around the secondary side 300 of the TRFP 100. As increasing current I_{L} is supplied to the load 390, less current I_{B} will flow through the bridge switch 332b (as I_{S}=I_{B}+I_{L}). As the voltage V_{B} is related to the magnitude of I_{B}, it will also fall. However, while the voltage V_{B} falls throughout the charging cycle, the voltage V_{B,M} generated during the maintenance phase remains constant (as the distribution of I_{S} does not affect this voltage). Indeed, this charging balance between voltage V_{B} and voltage V_{B,M} is what drives the shape of the transformer flux in FIG. 6. Initially, V_{B}>V_{B,M}, therefore, a residual flux in the same direction as the load current I_{L} remains in the transformer core. As I_{L} increases, V_{B} falls until V_{B,M} is greater. At this point, the flux in the core of the transformer will cross through zero before saturating in the opposite direction to the load current. This can be seen in FIG. 6. This saturation will occur irrespective of the transformer core size or magnitude of I_{L}; it is solely related to the choice of primary waveform. These observations are contrary to many conventional explanations for the origin of the DC offset in half-wave rectifier flux pumps.

While the discussion above separates the two factors 1) and 2), in practice the relative strength of each element will influence the other. Indeed, it is this correlation between the factors which has contributed to the observation that has led to certain aspects of the present technology.

The existence of the previously described DC offset is well established within the literature, and has conventionally been considered an inevitable part of the charging cycle. Previous research has understood the importance of the DC offset in limiting the performance. For example, prior work has considered how passive components (e.g. resistors) or an in-built DC offset within the primary waveform can improve performance of the TRFP. However, this research was predicated on the assumption that the DC offset was a fundamental aspect of flux pump operation.

Certain aspects of the present technology consider the substantial avoidance (or at least reduction) of the DC offset. In some forms, this may ensure that the performance of the transformer 150 remains constant throughout the charging of the load 390. It may also facilitate handling the effects of redistribution of the current I_{S}. The substantial avoidance of the DC offset may allow high-temperature superconductor TRFPs to achieve higher load currents in some forms, and may also enable a consistent performance from the TRFP.

To substantially avoid a DC offset as described, it has been identified that the integrated voltage V_{S} generated in the secondary coil 304 of the transformer 150 over a full cycle should be substantially zero. Consequently, some forms of the technology comprise a current control mechanism 203 configured to control the supply of alternating current to the TRFP 100, e.g. the primary coil 204 of the primary side 200 of the TRFP 100, so that the voltage Vs generated across the secondary coil 304 of the transformer 150 is substantially zero when integrated over a cycle. In the case of the half-wave rectifier 320 of the form of the technology shown in FIGS. 3B-3E, this is equivalent to the voltage across the bridge switch 332b in the charging phase of the circuit equaling the voltage across the switch 332a in the maintenance phase.

However, the magnitude of the voltages in the secondary side 300 of the TRFP 100 are dictated by the non-linear resistivity of the superconducting material(s) in the electrical switches 332. This makes it difficult to calculate the parameters of the desired primary waveform to achieve the necessary charging, especially while charging occurs and the current in the load 390 is progressively increasing. Consequently, in certain forms of the technology, the waveform of the primary current I_{P} is feedback-controlled during the process of charging of the load 390. Exemplary forms of such feedback control will be described below.

While some forms of the technology described below involve the use of a rectifier 320 in the form of a two-switch half-wave rectifier, in other forms other configurations of rectifier 320 in a TRFP 100 may be used, and the equivalent analysis and structure may be generated for such other forms.

In other forms of the technology, it may be desirable for the DC offset to be non-zero or a DC offset may be unavoidable, for example in the case of a centre-tapped full-wave rectifier as explained below. In such forms, the TRFP 100 may be configured so that the DC offset is non-zero but pre-determined, and optionally the same DC offset across multiple consecutive cycles. This may enable the DC offset to be accurately managed during charging of the load. Consequently, in some forms, the TRFP 100 may comprise a current control mechanism 203 configured to control the supply of alternating current to the TRFP 100, e.g. the primary coil 204 of the primary side 200 of the TRFP 100, so that a pre-determined DC offset in the secondary current is generated. In some forms, the pre-determined DC offset may be generated over a plurality of cycles, for example a plurality of consecutive cycles. In some forms, the pre-determined DC offset may be zero.

### 6.4.3. Waveform of the Primary Current

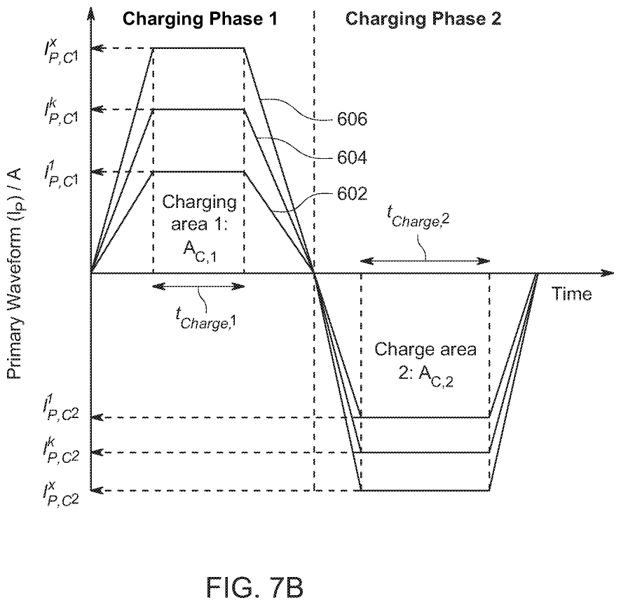

In certain forms of the technology, the current control mechanism 203 is configured to control the current source 202 to supply an applied current I_{P} to the primary coil 204. The applied current I_{P} may be an alternating current. In certain forms, the waveform of the applied current I_{P}, i.e. the variation of the current I_{P} with time, may be as shown in FIG. 7A, which is a graph showing the magnitude of alternating current I_{P} supplied to the primary coil 204 of TRFP 100 against time over the course of one cycle of current for a variety of stages in the process of charging the load 390. The waveform of the applied current I_{P} may be characterised by one or more values, referred to as the waveform values in this specification. The nomenclature of exemplary waveform values as shown in FIGS. 7A and 7B (and the following description) will now be explained.

In the first part of the cycle, which may be the first half of the cycle, the current flows through the primary coil 204 in a first direction, which is indicated as the current having a positive value in FIGS. 7A and 7B. The current increases from a first value, which may be zero, to a maximum value over a first period. The rate of increase in current may be substantially linear over this first period, as shown in FIGS. 7A and 7B. Over a second period, the current may be held at a substantially constant value, indicated as I_{P,C} in FIGS. 7A and 7B. This value may be referred to as the peak positive current. The duration of the second period is indicated as t_{charge} in FIGS. 7A and 7B. The current subsequently decreases from the maximum value to a lower value, which may be zero, over a third period. The rate of increase in current may be substantially linear over this third period, as shown in FIGS. 7A and 7B.

Subsequently, in the second part of the cycle, which may be the second half of the cycle, the current flows through the primary coil 204 in a second direction, opposite to the first direction, which is indicated as the current having a negative value in FIGS. 7A and 7B. The current decreases (i.e. becomes more negative, but increases in magnitude in the negative direction) from one value, which may be zero, to a maximum value over a fourth period. The rate of increase in current may be substantially linear over this first period, as shown in FIGS. 7A and 7B. Over a fifth period, the current may be held at a substantially constant value, indicated as I_{P,M} in FIGS. 7A and 7B. This value may be referred to as the peak negative current. The duration of the second period is indicated as t_{maintenance} in FIGS. 7A and 7B. The current subsequently increases from the maximum negative value to a higher value, which may be zero, over a sixth period. The rate of increase in current may be substantially linear over this sixth period, as shown in FIGS. 7A and 7B.

The waveform shown in FIGS. 7A and 7B may be considered to be an approximation of a square-wave primary current I_{P}. In certain forms, it may be advantageous for the second and fifth periods, i.e. the values of t_{charge} and t_{maintenance}, to be as small as practically possible. Therefore, in some forms, the waveform of the primary current I_{P} supplied to the primary coil 204 may approximate a triangular waveform. In certain forms, the values of t_{charge} and t_{maintenance} may be equal, or substantially equal. For the sake of simplicity, all periods other than t_{maintenance} and t_{charge} may be considered negligible, and this approach is taken in the remaining discussion.

The example of the waveform shown in FIGS. 7A and 7B may be used to supply the primary coil 204 of any one or more of the exemplary forms of TRFP 100 shown in FIGS. 3A to 3E. TRFP 100 comprises a rectifier 320 that operates as a half-wave rectifier. In such a form of TRFP 100, when the current flows in one direction in the primary coil 204, the rectifier 320 is in a configuration such that current is supplied from the secondary coil 304 to the load 390 and the load 390 is charged. And when the current flows in the opposite direction in the primary coil 204, the rectifier 320 is in a different configuration such that no current is supplied from the secondary coil 304 to the load 390 and instead the current in the load 390 is maintained by virtue of the superconducting loop through the bridge switch 332b. Consequently, the first part of the cycle of the waveform shown in FIGS. 7A and 7B, i.e. the first, second and third periods when the current is positive, may be referred to as the “charging phase”, and the second part of the cycle of the waveform shown in FIGS. 7A and 7B, i.e. the fourth, fifth and sixth periods when the current is negative, may be referred to as the “maintenance phase”. This is the reason for the subscripts “C” and “M” in the notation I_{P,C} and I_{P,M}.

In FIGS. 7A and 7B, a number of different primary current waveforms 602, 604, 606 are shown with different magnitudes of peak positive and negative current. Each primary current waveform 602, 604, 606 may represent the waveform of the primary current I_{P} for a different cycle. As will be explained later, certain characteristics of the primary current I_{P} waveform may change over the course of cycles in order to charge the load 390 in the desired manner. In some forms, the characteristics may change after each cycle while in other forms the characteristics may remain the same for a certain number of cycles and then change for subsequent cycles.

In certain forms, the value of the peak positive current I_{P,C} and/or the value of the peak negative current I_{P,M} may be adjusted through a series of cycles. The value of the peak positive current in the k^{th} cycle is

$${I}_{P , C}^{k}$$

and the value of the peak negative current in the k^{th} cycle is

$${I}_{P , M}^{k} .$$

In FIGS. 7A and 7B, waveform 602 indicates the first current cycle so the respective peak positive and negative current values are

$${I}_{P , C}^{1} and {I}_{P , M}^{1} .$$

Waveform 606 indicates the current once the load current in the load 390 has reached the desired level and the respective peak positive and negative current values in this cycle are

$${I}_{P , C}^{x} and {I}_{P , M}^{x} .$$

In certain forms, the peak positive and negative current values in the primary current waveform may generally increase with time, i.e. as the number of cycles increases. For example,

$${I}_{P , C}^{k + 1}$$

may be greater than

$${I}_{P , C}^{k} and {I}_{P , M}^{k + 1}$$

may be greater than

$${I}_{P , M}^{k} .$$

In the forms of the technology discussed above and below, the peak current value is described as the exemplary waveform value that is varied between cycles in order to moderate the generated output voltages. However, in other forms, other waveform values may be varied between cycles. Examples include altering the magnitude of t_{maintenance} and t_{charge}. In still other forms, the strength and/or direction of the applied magnetic field may be varied between cycles. In some forms, one or more of these values may be varied. The process for integrating these approaches may be similar to the methodology outlined below and can, therefore, be modified to include a range of waveform variations in addition to or in place of peak current modification. Forms involving the variation of peak current are described herein for reasons of simplicity of description.

### 6.4.4. Other Nomenclature

In addition to the nomenclature already introduced, in the ensuing description, the following will be used:

$${I}_{L}^{k}$$

is the load current supplied to the load 390 at the start of the k^{th} cycle;
ΔI_{L} is the change in load current supplied to the load 390 over a current cycle. In some forms, this value may be constant for the process of charging load 390 while in other forms the value may change over time, for example if varying ramp rates are required;

$$Δ {I}_{L , C}^{k}$$

is the change in load current supplied to the load 390 in the charging phase of the k^{th} cycle;

$$Δ {I}_{L , M}^{k}$$

is the change in load current supplied to the load 390 in the maintenance phase of the k^{th} cycle;

$${I}_{S , C}^{k}$$

is the peak current generated in the secondary coil 304 in the charging phase of the k^{th} cycle;

$${I}_{S , M}^{k}$$

is the peak current generated in the secondary coil 304 in the maintenance phase of the k^{th} cycle;
N₁ is the number of turns in the primary coil 204 of the transformer 150;
N₂ is the number of turns in the secondary coil 304 of the transformer 150;
t_{Cycle} is the time of a total cycle (i.e. the sum of the durations of the first and second parts of the cycle, or the sum of the durations of the first to sixth periods as described above);

$${V}_{Coil}^{k}$$

is the time-averaged voltage generated across the load 390 (which may be a coil) in the charging phase of the k^{th} cycle;

$${V}_{B}^{k}$$

is the time-averaged voltage generated across the bridge (e.g. across the bridge switch 332b in the form shown in FIGS. 3B-3E) in the charging phase of the k^{th} cycle;

$${V}_{M}^{k}$$

is the time-averaged voltage generated across the series switch 332a in the form shown in FIGS. 3B-3E in the maintenance phase of the k^{th} cycle;

$${V}_{C , Req}^{k}$$

is the voltage across the bridge (e.g. across the bridge switch 332b in the form shown in FIGS. 3B-3E) in the charging phase of the k^{th} cycle required to achieve the desired charging of the load 390;

$${V}_{M , Req}^{k}$$

is the voltage across the series switch 332a in the form shown in FIGS. 3B-3E in the maintenance phase of the k^{th} cycle required to achieve the desired charging of the load 390; and

$${I}_{B}^{k}$$

is the current through the bridge (e.g. through the bridge switch 332b in the form shown in FIGS. 3B-3E) in the charging phase of the k^{th} cycle.

### 6.4.5. Characterisation of Response to Characterisation Supply

It has been explained that, in some forms, the supply of applied current I_{P} supplied to the primary coil 204 is controlled in order to charge the load 390 in a desired manner. For example, the load 390 may be charged by increasing the magnitude of the load current I_{L} supplied to the load in a step-wise fashion so that the magnitude of the load current I_{L} incrementally increases after a certain number of cycles, for example after each cycle. In some forms, the supply of applied current I_{P} supplied to the primary coil 204 may be controlled in order to incrementally increase the load current I_{L} by substantially the same amount at each increment. This may be referred to as “linear ramping” of the load 390.

Because of the non-linear resistivity of the superconducting materials in the TRFP 100, precise control and management of the flux pump's electromagnetic state is difficult. Consequently, in some forms of the technology, the response of the TRFP 100 is experimentally characterised prior to charging the load 390, i.e. prior to commencing the supply of alternating current to the TRFP 100 that serves to charge the load 390 to the desired level.

In certain forms of the technology, the characterisation stage may not be implemented and control may be determined solely by analysis of the TRFP 100, for example through solving, or approximating solutions to, analytical equations derived directly from considerations of the topology and construction of the TRFP 100.

In some forms, the response of the TRFP 100 may be experimentally characterised, at least in part, while the charging of the load 390 is in process, e.g. some steps of experimentally characterising the response of the TRFP 100 may occur while the load 390 is partially charged towards the desired level of charging.

The characterisation of the response of the TRFP 100 may comprise characterising a response of the rectifier 320 and/or the load 390.

The characterisation of the response of the TRFP 100 may comprise supplying a characterisation supply of applied current to the primary coil 204 of the transformer 150. The current source 202 and the current control mechanism 203 may be used to provide the characterisation supply of current but, in other forms, a different current source and current control mechanism from those which will be eventually used to charge the load 390 may be used. In certain forms, the characterisation supply of applied current has the same or a substantially similar waveform to the waveform of the applied current supply that will be supplied to the primary coil 204 when charging the load 390. For example, the duration of each part of the cycle of the characterisation supply may be the same as the charging supply. In addition, the duration of each period of the cycle of the characterisation supply may be the same (or substantially the same) as the charging supply, including the values of t_{charge} and t_{maintenance} being the same (or substantially the same) for the characterisation supply as for the charging supply. The values of the peak positive and negative current may vary for both the characterisation and charging supply of current, as will be explained.

In certain forms of the technology, any one or more of a number of parameters of the TRFP 100 may be determined as part of characterising the response of the TRFP 100 to the characterisation supply. In certain forms, one or more values of voltage in the rectifier 320 that correspond to a given value of current supplied to the primary coil 204 are determined. For example, the value of the voltage output to the load 390 may be determined. In the form of the half-wave rectifier 320 shown in FIGS. 3B-3E, the voltage output to the load 390 may be the voltage V_{B} across the bridge, i.e. across the bridge switch 332b. In addition, the value of the current I_{B} flowing through the bridge, i.e. through the bridge switch 332b, that corresponds to each of the determined voltage values may be determined. In certain forms, the values corresponding to the peak value of current in the waveform provided to the primary coil 204 (either I_{P,C} or I_{P,M} depending on whether it is the charging or maintenance phase) are determined.

In certain forms of the technology, there is provided the necessary measurement devices used to directly measure these parameters, or to measure other parameters from which these parameters may be indirectly determined, for example through calculation. Measurement devices may comprise one or more voltage sensors and one or more current sensors. It should be appreciated that, any determination of a parameter of the TRFP 100 that is necessary for the ensuing description, but for which no explicit mention of a measurement device for determining that parameter is made, may be implemented through the use of an appropriate sensor.

The correspondence between multiple values of one parameter and multiple values of another parameter, for example a value of voltage in the rectifier as corresponding to a value of the primary current, may be stored in a data storage device in an appropriate form, for example in a data array or look-up table.

In an operational TRFP 100, the characterisation of the response may be performed on a regular or frequent basis, for example every few hours, days or weeks, depending on the nature of the TRFP 100 and its use.

More specific details of the characterisation of the response of the TRFP 100 in certain forms of the technology will now be described. In particular, in the case of a TRFP 100 comprising certain types of rectifier 320, for example the half-wave rectifier 320 of FIG. 3B-3E, the characterisation of the response of the TRFP 100 may comprise characterising the response of the TRFP 100 in the charging phase and also characterising the response of the TRFP 100 in the maintenance phase. It will be appreciated that, in the case of a rectifier in which both phases of the waveform correspond to charging, for example a full-wave rectifier, only the description of characterising the response in the charging phase may apply.

### 6.4.5.1. Characterisation in the Charging Phase—Characterisation Tables

In certain forms of the technology, the TRFP 100 may be characterised in the charging phase, e.g. when the rectifier 320 of FIGS. 3B-3E is in a configuration in which a current generated in the secondary coil is supplied to the load 390, in order to determine values of voltage in the rectifier 320, for example values of voltage V_{B} across the bridge switch 332b and output to the load 390, that correspond to values of alternating current supplied to the primary coil 204, for example peak values of current I_{P,C} in the positive direction.

In an exemplary form, a TRFP 100, such as is shown in FIGS. 3A-3E, is assembled and a load 390 is connected as described above. In addition, the rectifier 320 is put into the configuration in which a current generated in the secondary coil 304 is supplied to the load 390, e.g. in the case of the half-wave rectifier 320 of FIGS. 3B-3E, the bridge switch 332b is put into the higher-resistance state and the switch 332a is put into the lower-resistance state. As explained above, a magnetic field may be applied to the bridge switch 332b by a magnetic field generator in order to achieve this.

To characterise the TRFP 100, a plurality of characterisation signals of the applied current with the same or substantially similar waveform to that which will be used for charging spanning the expected range of applied currents is applied. For example, a plurality of characterisation supplies having different waveform values, e.g. peak positive values I_{P,C}, may be sequentially supplied to the primary coil 204 of the transformer 150. The levels of the characterisation supplies of applied current may be such that the transformer 150 does not saturate. As each characterisation supply of applied current is supplied, the value of the voltage V_{B}(I_{B}) across the bridge switch 332b and output to the load 390 is measured and recorded. After each characterisation supply of current, the load current I_{L} in the load 390 may be allowed to decay to zero before the next characterisation supply is supplied. This may ensure that the current in the secondary coil 304 equals the current in the bridge switch 332b (i.e. I_{S,C}=I_{B}) at the start of each characterisation step. Furthermore, it is assumed that V_{B}(I_{B})=V_{S,C}(I_{S,C}) for the TRFP 100 in this form, although variations from this equivalence could be quantified and integrated if necessary.

The value of V_{B}(I_{B}) may be determined for a large range of bridge currents I_{B} that are possible for the particular design of TRFP 100. Consequently, a corresponding range of waveform values of applied current characterisation supplies are provided to the primary coil 204.

In this way, the conditions of charging the load 390 are replicated in the characterisation stage, including all potential real-world variations from the modelled behaviour of the TRFP 100 described later. In addition, this characterisation process may also be useful in establishing the capabilities of the TRFP 100.

It is noted that, in certain forms, V_{B}(I_{B}) may have no dependence on the load current. In such forms, as ΔI_{L}∝V_{B}(I_{B}), one characterisation may be assumed to hold for all possible experimental variables irrespective of load current. In other forms, V_{B}(I_{B}) may be dependent on the load current or ramp rate, for example AC loss and/or inductive coupling may alter the effective voltage generated. Additional terms may be added to the relevant equations to account for these effects. Alternatively, as will be discussed, a feedback loop, for example in the form of a PID loop, may account for such effects.

In certain forms, the process of supplying a plurality of characterisation supplies to the primary coil 204 to characterise the behaviour of the TRFP 100 may only be performed during initial installation and prior to the charging process commencing although, in other forms, one or more subsequent characterisation steps may occur in which a further one or more characterisation supplies of applied current are supplied to the primary coil 204. For example, periodic checking of the characterised behaviour of the TRFP 100 may be performed.

In certain forms, the result of the process of providing characterisation current supplies and measuring parameters of the TRFP 100 in the charging phase may be a series of values of bridge currents I_{B} and their associated voltage values V_{B}(I_{B}) across the bridge for the TRFP 100 in question. In certain forms, this series of values may be stored or presented as a data array, for example a look-up table of V_{B}(I_{B}) vs. I_{B}. An example of a look-up table in one form of the technology is presented in Table 1:

TABLE 1
an exemplary look-up table
characterising the TRFP 100 in the charging phase

| I_{B} (A) | V_{B}(I_{B}) (V) |
|---|---|
| 0 | 0 |
| 1 | 0 |
| . . . | . . . |
| 1.5I_{C,B} | 1.165 |

The increments between the values of the bridge current I_{B} ascertained in the characterising process may be selected as appropriate. In certain forms, a variety of increments may be used. For example, the spacings between each value of I_{B} may be reasonably broad (e.g. 10-20A steps) when the current I_{B} is less than the critical current I_{C,B} of the bridge switch 332b. Additional values of current and the corresponding voltage in this range may be generated through interpolation. The spacing between the values of current I_{B} may reduce, including significantly reduce, as the current approaches the critical current I_{C,B} of the bridge switch 332b, for example if the current is within approximately 20-30% of the critical current I_{C,B}, the spacing may reduce to approximately 1A between values. Measurements may be taken up to a maximum value of I_{B}, which may be above the critical current I_{C,B} of the bridge switch 332b, for example 1.5I_{C,B}.

At this stage it has been established what currents in the bridge 332b I_{B} generate certain voltages across the bridge V_{B}(I_{B}) to be provided to the load 390 (e.g. Table 1). In certain forms, the next step is to calculate the correlation between I_{B} and the input primary current, for example the peak positive value of the input primary current I_{P,C}.

The bridge current I_{B} will be reduced by the load current I_{L} so the required current generated in the secondary coil 304 scales with the increasing load current according to:

$${I}_{S , C}^{k} = {I}_{L}^{k} + {I}_{B}^{k}$$

This current is related to I_{P,C} based on the winding ratio of the transformer 150 as:

$${I}_{P , C} = \frac{{N}_{2}}{{N}_{1}} {I}_{S , C}^{k}$$

Therefore, a series of voltage values V_{B}(I_{B}) across the bridge (and/or provided to the load 390) and the corresponding peak positive current values I_{P,C} provided to the primary coil 304 can be determined, for example in the form of another look-up table such as presented in Table 2:

TABLE 2
an exemplary look-up table characterising the TRFP 100 in the charging
phase

| I_{P,C} (A) | V_{B}(I_{B}) (V) |
|---|---|
| 0 | 0 |
| 1 | 0 |
| . . . | . . . |
| $0.8 \frac{{N}_{2}}{{N}_{1}} {I}_{S , C}^{k}$ | 0.022 |
| . . . | . . . |
| $2 \frac{{N}_{2}}{{N}_{1}} {I}_{S , C}^{k}$ | 1.261 |

### 6.4.5.2. Characterisation in the Maintenance Phase

In the case of forms of TRFP 100 in which there is a maintenance phase in addition to a charging phase, for example for a half-wave rectifier 320 such as shown in FIGS. 3B-3E, a similar process of characterising the TRFP in the maintenance phase may be performed in order to determine values of voltage in the rectifier 320, for example values of voltage V_{M} across the series switch 332a, that correspond to values of alternating current supplied to the primary coil 204, for example peak values of current I_{P,M} in the negative direction.

In an exemplary form, a TRFP 100, such as is shown in FIGS. 3A-3E, is assembled. The load 390 may or may not be connected for this characterisation step. In addition, the rectifier 320 is put into the configuration in which no current is supplied from the secondary coil to the load 390, e.g. in the case of the half-wave rectifier 320 of FIGS. 3B-3E, the bridge switch 332b is put into the lower-resistance state and the switch 332a is put into the higher-resistance state. As explained above, a magnetic field may be applied to the bridge switch 332a in order to achieve this.

Then, a plurality of characterisation supplies of applied current having the same or substantially similar waveform to that which will be used for charging, and with the plurality of characterisation supplies having different waveform values, e.g. peak negative values I_{P,M}, may be sequentially supplied to the primary coil 204 of the transformer 150. The levels of the characterisation supplies of applied current may be such that the transformer 150 does not saturate. As each characterisation supply of alternating current is supplied, the value of the voltage V_{M}(I_{S}) across the series switch 332a is measured and recorded. Unlike the characterisation of the charging phase, after each characterisation supply of current, the load current I_{L} in the load 390 does not need to decay to zero before the next characterisation supply is supplied.

As with the characterisation of the charging phase, the value of V_{M}(I_{S}) may be determined for a large range of currents I_{S} through the series switch 332a that are possible for the particular design of TRFP 100. Consequently, a corresponding range of values of applied current characterisation supplies are provided to the primary coil 204. A number and range of values of current I_{S} that is similar to that explained above for the values of I_{B} in the charging phase may be applied, e.g. similar increments and maximum value.

As explained in relation to the charging phase, in certain forms, the process of supplying a plurality of characterisation supplies to the primary coil 204 to characterise the behaviour of the TRFP 100 may only be performed during initial installation and prior to the charging process commencing although, in other forms, one or more subsequent characterisation steps may occur in which a further one or more characterisation supplies of applied current are supplied to the primary coil 204. For example, periodic checking of the characterised behaviour of the TRFP 100 may be performed.

In certain forms, the result of the process of providing characterisation current supplies and measuring parameters of the TRFP 100 in the charging phase may be a series of values of currents I_{S} through the series switch 332a and their associated voltage values V_{M}(I_{S}) across the series switch 332a for the TRFP 100 in question. In certain forms, this series of values may be stored or presented as a data array, for example a look-up table of V_{M}(I_{S}) vs. I_{S}. One example of a look-up table in one form of the technology is presented in Table 3:

TABLE 3
an exemplary look-up table
characterising the TRFP 100 in the maintenance phase

| I_{S} (A) | V_{M}(I_{S}) (V) |
|---|---|
| 0 | 0 |
| 1 | 0 |
| . . . | 0 |
| 1.5I_{C,S} | 1.165 |

At this stage it has been established what currents in the series switch 332a I_{S} generate certain voltages across the switch V_{M}(I_{S}) (e.g. Table 3). In certain forms, the next step is to calculate the correlation between I_{S} and the input primary current, for example the peak negative value of the input primary current I_{P,M}. These are related based on the number of windings in the transformer 150 as:

$${I}_{S} = {I}_{S , M} = \frac{{N}_{1}}{{N}_{2}} {I}_{P , M}$$

And consequently:

$${I}_{P , M} = \frac{{N}_{2}}{{N}_{1}} {I}_{S}$$

Therefore, a series of voltage values V_{M}(I_{S}) through the series switch 332a (and/or in the secondary coil 304) and the corresponding peak negative current values I_{P,M} provided to the primary coil 304 can be determined, for example in the form of another look-up table such as presented in Table 4:

TABLE 4
an exemplary look-up table characterising the TRFP 100 in the
maintenance phase

| I_{P,M} (A) | V_{M}(I_{S}) (V) |
|---|---|
| 0 | 0 |
| 1 | 0 |
| . . . | . . . |
| $0.8 \frac{{N}_{2}}{{N}_{1}} {I}_{C , M}$ | 0.022 |
| . . . | . . . |
| $2 \frac{{N}_{2}}{{N}_{1}} {I}_{C , M}$ | 1.261 |

### 6.4.6. Target Value Calculation

After the characterisation stage, it is understood how the TRFP 100 will respond to certain supply currents in each of the charging phase and, if applicable, the maintenance phase. Another aspect may be the creation of analytically derived target values which account for the dynamic response of the flux pump as outlined in section 6.4.2. To clarify, the target values are the required voltages for the switches during the charging process. The target values may embed the requirements of the charging process, such as DC offset control and ramp rate, into the system. Determining the target values requires an understanding of the physical mechanisms inherent within the TRFP and a skilled analysis to create the necessary equations to generate them.

Another aspect of the control process in some forms of the technology is taking the derived target values, which represent required outputs, and mapping them to required inputs. The inputs in a general TRFP are the applied primary current waveform and, in the case of magnetic field-driven switching, the electromagnet(s) waveform(s). Therefore, the term ‘waveform values’ will be used to encompass the changes to the input variables caused by the control process. Another way of describing the waveform variations is that they may be the changes to the inputs which produce the required target values. It is this unique combination of elements which forms the basis of certain forms of the technology.

In a general approach taken in certain forms of the technology, it is decided what is the target load current I_{target} to be supplied to the load 390 at the end of the charging process, i.e. to what level the load 390 should be charged. It is also decided the rate at which the load 390 should be charged and, based on the period of the cycle of the applied current to be supplied to the primary coil 204, this determines the change in load current ΔI_{L} supplied to the load 390 over a current cycle. As explained earlier, the change in load current ΔI_{L} may vary over the course of the charging process although, in the case of linear ramping, the change in load current ΔI_{L} may be selected to be substantially constant over the course of the charging process. Based on the target load current and the target rate of charging the load 390, the waveform values for the applied current to the primary coil 204 for each cycle are calculated. In the discussion below, the waveform values take the form of the peak positive current I_{P,C} and the peak negative current I_{P,M} in each cycle supplied to the primary coil 204. In other forms, different values, such as other waveform values for the applied current or values characterising the waveform of the magnetic field strength and/or direction generated by the magnetic field generator 342, may be calculated and changed to achieve the same or similar effect.

The waveform values of applied current to be supplied to the primary coil 204 (e.g. I_{P,C} and I_{P,M}) for each value of target load current I_{L} are calculated by initially calculating target values of voltage for the TRFP 100 that are expected to produce the required target load current I_{L}. This can be achieved prior to the flux pump charging as, as will be shown below, the target values can be derived analytically. Then the method comprises calculating the waveform values of the applied currents to be supplied to the primary coil 204 or magnetic field generator 342 from the target values of voltage as derived from the characterisation tables or separate numerical or analytical solutions. In certain forms, for example in the form of the half-wave rectifier 320 shown in FIGS. 3B-3E, the target values may comprise one or more target values of voltage when the rectifier 320 is in a configuration in which a current is supplied from the secondary coil 304 to the load 390 (i.e. the charging phase) and one or more target values of voltage when the rectifier 320 is in a configuration in which no current is supplied from the secondary coil to the load 390 (i.e the maintenance phase). In certain forms, the target values of voltage may comprise one or more target values of voltage to be provided to the load 390, e.g. the voltage across the bridge switch 332_{b}

$${V}_{C , Req}^{k} ,$$

and one or more target values of voltage across the series switch 332a

$${V}_{M , Req}^{k} .$$

In certain forms, the waveform values of the applied currents are determined from the voltage values using the results of characterising the response of the TRFP 100, for example using the look-up tables such as Tables 2 and 4.

In certain forms, the waveform values of the applied currents may be determined by using numerical or analytical solutions of the superconducting characteristics of the TRFP 100 and detailed analysis of the TRFP 100 configuration. One exemplary such form is discussed in section 6.4.7.1

In certain forms, the waveform values may be modified by feedback loops based on the measured response—as discussed in section 6.4.7.

An exemplary process of determining the characteristics of the supply of the applied currents that are required for the TRFP 100 to achieve the desired load current in the load 390 will now be described in more detail. While the exemplary process outlined below creates the set of target values before charging initiation, in certain forms, these target values may be generated during charging utilising the same principles.

### 6.4.6.1. Modelling of a Half-Wave Rectifier—Creation of Target Values

The following section describes how a rectifier 320 in the form of a half-wave rectifier 320 such as shown in FIGS. 3B-3E may be modelled in certain forms of the technology. It is anticipated that the skilled addressee will, on reading this description, be able to perform similar modelling for other forms of rectifier, including other forms of half-wave rectifier and full-wave rectifiers. Consequently, detailed analysis is not provided for other exemplary forms of rectifier 320, although a brief overview for centre-tapped full-wave rectifier is discussed further below.

In the following derivation, two factors are focused on as determining the output voltage of a half-wave rectifier that comprises switches 332 that operate on the basis of applying a magnetic field to a length of superconductor in order to change the critical current of the superconductor. These are: 1) the non-linear resistivity caused by the combination of applied magnetic field and current; and 2) the joint resistances created during assembly. For existing rectifier of this type, it has been shown that these factors do, in fact, dominate the voltage response. However, inductive coupling and AC loss mechanisms have been shown to influence the output voltage. In certain forms, these mechanisms may lead to variations in the voltage output which cannot be mitigated by the use of PID feedback control as suggested in the following discussion. In these forms, integrating these additional components into the target value equations may be necessary. An individual skilled in the art will be capable of implementing these additions following the process outlined below. It is important to note that the overarching methodology remains unaltered irrespective of the physical mechanism driving the rectification process for type-II superconductor transformer rectifier flux pumps.

As has been explained, when deciding how to charge a load 390 using TRFP 100, two characteristics may be decided: the rate of charging (which is related to ΔI_{L}) and the target load current in the load 390 (I_{Target}). In a TRFP 100, the charging rate is defined by the voltage generated across the load 390 over an entire cycle of input current

$$( {\int }_{0}^{{t}_{Cycle}} {V}_{Coil} dt ) .$$

In modelling the TRFP 100, the charging and maintenance phases are considered separately as the mechanisms driving the voltage V_{Coil} across the load 390 are different in each cycle. Indeed, in the maintenance phase the performance may be considered in terms of current dissipation in a RL circuit since the voltage V_{Coil} in this phase is driven by losses rather than an external driving voltage. In which case, V_{Coil} is precisely the inductive voltage across the coil:

$${V}_{Coil} = {L}_{Coil} \frac{{dI}_{L}}{dt} \qquad ( Equation 1 )$$

where L_{Coil} is the inductance of the load 390 only. The target value generation is necessary to ensure that the TRFP 100 produces the correct V_{Coil} to create the required

$$\frac{{dI}_{L}}{dt}$$

as defined by the user, for example every cycle. As will be shown below, a single V_{Coil} may be insufficient to satisfy examples of TRFP 100 in which the load 390 is charged with a progressively increasing load current, where the switching assembly 330 behaves non-linearly and to ensure the preferential net zero flux is generated across each cycle. Instead, V_{Coil} may need to change for each cycle

$$( {V}_{Coil}^{k} )$$

to handle the dynamic changes in behaviour caused by the charging necessitating variations in the input parameters (waveform values).

In certain forms of the technology, to find

$${V}_{Coil}^{k}$$

several assumptions may be made. One assumption is that the charging of the load 390 can be accurately characterised by simplifying the dynamic V_{Coil} into a time averaged value. Experiments have shown that this approximation is highly accurate. Other forms of the control process may directly consider the time response of

$${V}_{Coil}^{k} ( t ) .$$

Using a time averaged

$${V}_{Coil}^{k} , ,$$

we consider how to calculate the required

$${V}_{Coil}^{k}$$

to achieve the desired ΔI_{L}. To do this, we calculate the change in current for both the charging

$$( Δ {I}_{L . C}^{k} )$$

and maintenance

$$( Δ {I}_{L , M}^{k} )$$

phases.

For the charging phase, using the time-averaged voltage leads to a linear ramping rate during the charging process, which means equation 1 give

$$Δ {I}_{L . C}^{k}$$

as:

$$Δ {I}_{L . C}^{k} = \frac{{V}_{Coil , C}^{k} {t}_{Charge}}{{L}_{Coil}} \qquad ( Equation 2 )$$

However, the loss in load current during the maintenance phase is more complex. The

$$Δ {I}_{L . M}^{k}$$

is now determined by

$${V}_{Coil , M}^{k} ( t ) but {V}_{Coil , M}^{k}$$

is determined by the RL circuit within the load loop and, as will be shown, the current generated by the transformer 150 in the maintenance phase. In terms of the load current during the maintenance phase (I_{L,M}(t)) and Kirchhoff's loop law in the load loop,

$${V}_{C oil , M}^{k}$$

is:

$${V}_{C oil , M}^{k} ( t ) = {R}_{L} {I}_{L , M} ( t ) + ( {I}_{L , M} ( t ) + {I}_{S , M}^{k} ) {R}_{J} = {L}_{C o i l} \frac{{dI}_{L , M} ( t )}{d t}$$

where

$${L}_{Coil} \frac{{dI}_{L . M} ( t )}{dt}$$

originates as the load coil 390 response is completely determined by inductive behaviour. This can be rearranged into:

$$\frac{{dI}_{L . M} ( t )}{d t} = \frac{( {R}_{J} + {R}_{L} )}{{L}_{Coil}} {I}_{L , M} ( t ) + \frac{{R}_{J} {I}_{S , M}^{k}}{{L}_{Coil}}$$

$$\frac{{dI}_{L , M} ( t )}{d t} = {AI}_{L , M} ( t ) + B$$

where

$$A = \frac{( {R}_{J} + {R}_{L} )}{{L}_{Coil}} and B = \frac{{R}_{J} {I}_{S , M}^{k}}{{L}_{Coil}}$$

are constants. This enables the integration to become:

$${I}_{L , M} ( t ) = ( {I}_{L}^{k} + Δ {I}_{L . C}^{k} + \frac{{I}_{S , M}^{k} {R}_{J}}{{R}_{J} + {R}_{L}} ) ( {e}^{- ( {R}_{J} + {R}_{L} ) t} / {L}_{Coil} ) - \frac{{R}_{J} {I}_{S , M}^{k}}{{R}_{J} + {R}_{L}}$$

Consequently, the voltage in the load loop during the maintenance phase changes with time (even with a constant

$${I}_{S , M}^{k} ) .$$

### As

$${V}_{Coil , M}^{k} ( t ) = {L}_{Coil} \frac{{dI}_{L . M} ( t )}{dt} :$$

$${V}_{Coil , M}^{k} ( t ) = - \frac{{L}_{Coil} {R}_{J} {I}_{S , M}^{k}}{{R}_{J} + {R}_{L}} ( {I}_{L}^{k} + Δ {I}_{L . C}^{k} + \frac{{I}_{S , M}^{k} {R}_{J}}{{R}_{J} + {R}_{L}} ) ( {e}^{- ( {R}_{J} + {R}_{L} ) t} / {L}_{Coil} )$$

In some forms, analysis may enable this change to be accounted for explicitly. However, in certain forms, for the sake of simplicity, the voltage may be assumed to be constant through the maintenance phase. Experiments have shown that, for a 5 Hz operation with a set of parameters comparable to real-world systems, the effect of this assumption is around 90 μV although this is highly system dependent. As will be discussed later, these assumptions form part of a range of effects not directly handled by these analytical equations and therefore may be managed by an additional technique.

Irrespective of this assumption,

$$Δ {I}_{L , M}^{k} ( {t}_{M a i n t e n a n c e} ) = Δ {I}_{L , M}^{k}$$

as defined above:

$$Δ {I}_{L , M}^{k} = ( {I}_{L}^{k} + Δ {I}_{L . C}^{k} + \frac{{I}_{S , M}^{k} {R}_{J}}{{R}_{J} + {R}_{L}} ) ( {e}^{- ( {R}_{J} + {R}_{L} ) {t}_{Maintenance}} / {L}_{Coil} ) - \frac{{R}_{J} {I}_{S , M}^{k}}{{R}_{J} + {R}_{L}} - {I}_{L}^{κ} - Δ {I}_{L . C}^{k} = γ ( {I}_{L}^{k} + Δ {I}_{L . C}^{k} + {KI}_{S , M}^{k} ) - {KI}_{S , M}^{k} - {I}_{L}^{k} - Δ {I}_{L . C}^{k} = {I}_{L}^{k} ( γ - 1 ) + Δ {I}_{L . C}^{k} ( γ - 1 ) + {KI}_{S , M}^{k} ( γ - 1 ) \qquad ( Equation 3 )$$

where

$$γ = {e}^{- ( {R}_{J} + {R}_{L} ) {t}_{M a t n t e n a n c e}} / {L}_{Coil} and K = \frac{{R}_{J}}{{R}_{J} + {R}_{L}}$$

are constants. This equation says that the loss in the maintenance phase is related to the secondary current generated in the maintenance phase

$$( {I}_{S , M}^{k} )$$

which has not yet been calculated. This creates an inevitable circularity in the calculation. To counteract this circularity, we assume that that

$${I}_{S , M}^{k}$$

will not change significantly between consecutive cycles. For a working control process with a constant ramp rate this is the expected behaviour. Therefore,

$${I}_{S , M}^{k}$$

may be assumed to be

$${I}_{S , M}^{J} ,$$

the value of I_{S,M} from the previous cycle. Utilising assumption, equation 3 becomes:

$$Δ {I}_{L , M}^{k} ≅ {I}_{L}^{k} ( γ - 1 ) + Δ {I}_{L . C}^{k} ( γ - 1 ) + {KI}_{S , M}^{j} ( γ - 1 ) \qquad ( Equation 4 )$$

For the nature of the control process, we are interested in ensuring that the total change in load current over the whole cycle (ΔI_{L}) matches the user defined charging rate:

$$Δ {I}_{L} = Δ {I}_{L , C}^{k} + Δ {I}_{L , M}^{k}$$

$$Δ {I}_{L} ≅ Δ {I}_{L , C}^{k} + {I}_{L}^{k} ( γ - 1 ) + Δ {I}_{L , C}^{k} ( γ - 1 ) + {KI}_{S , M}^{j} ( γ - 1 )$$

$$Δ {I}_{L} ≅ γΔ {I}_{L , C}^{k} + Δ {I}_{L , C}^{k} ( γ - 1 ) + {KI}_{S , M}^{j} ( γ - 1 )$$

Using equation 2:

$$Δ {I}_{L} + {I}_{L}^{k} ( 1 - γ ) + {KI}_{S , M}^{j} ( 1 - γ ) ≅ \frac{γ {t}_{Charge}}{{L}_{Coil}} {V}_{Coil , C}^{k} ( {I}_{L}^{k} , {I}_{S , M}^{j} )$$

Everything in the above equation is now defined or determined by characterising in the existing experimental state. This means we can rearrange to find the required

$${V}_{Coil , C}^{k}$$

to generate the desired ΔI_{L}:

$${V}_{Coil , C}^{k} ( {I}_{L}^{k} , {I}_{S , M}^{j} ) ≅ \frac{{L}_{Coil} ( Δ {I}_{L} + {I}_{L}^{k} ( 1 - γ ) + {KI}_{S , M}^{j} )}{γ {t}_{Charge}} \qquad Equation ( 5 )$$

Equation 5 is an equation for

$${V}_{Coil}^{k}$$

based on parameters known for the first current cycle. The only variable that must be added is a reasonable assumption for

$${I}_{S , M}^{j}$$

in the first cycle, and one example of how this may be achieved is discussed below.

However, while equation 5 handles the voltage generated across the coil

$$( {V}_{Coil}^{k} ) ,$$

the voltage importance for the TRFP 100 may be the voltage across the bridge

$${V}_{C , Req}^{k} ( {I}_{L}^{k} , {I}_{S , M}^{k} ) .$$

Therefore, we now work out the conversion between these two values. Using FIG. 2, this is:

$${V}_{C , Req}^{k} ( {I}_{L}^{k} , {I}_{S , M}^{k} ) \approx {V}_{Coil}^{k} ( {I}_{L}^{k} , {I}_{S , M}^{j} ) + {I}_{L , Ave}^{k} {R}_{L}$$

where

$${I}_{L , Ave}^{k}$$

is the average

$${I}_{L}^{k}$$

over the k^{th} cycle. Essentially, the resistance of the load loop (R_{L}) means that more voltage must be generated across the bridge to generate the required

$${V}_{Coil}^{k} ( {I}_{L}^{k} , {I}_{S , M}^{j} ) .$$

Using the linear ramp rate assumption,

$${I}_{L , Ave}^{k}$$

can be calculated:

$${I}_{L , Ave}^{k} = {I}_{L}^{k} + Δ {I}_{L , Ave}^{k} \approx {I}_{L}^{k} + \frac{{V}_{Coil}^{k} ( {I}_{L}^{k} , {I}_{S , M}^{j} )}{{L}_{Coil} {t}_{Charge}} {\int }_{0}^{{t}_{Charge}} t dt = {I}_{L}^{k} + \frac{{V}_{Coil}^{k} ( {I}_{L}^{k} , {I}_{S , M}^{j} ) {t}_{charge}}{2 {L}_{Coil}} = {I}_{L}^{k} + \frac{Δ {I}_{L , C}^{k}}{2}$$

which means that:

$${V}_{C , Req}^{k} ( {I}_{L}^{k} , {I}_{S , M}^{k} ) \approx {V}_{Coil}^{k} ( {I}_{L}^{k} , {I}_{S , M}^{j} ) + ( {I}_{L}^{k} + \frac{Δ {I}_{L . C}^{k}}{2} ) {R}_{L} \qquad ( Equation 6 )$$

It is noted that all the resistance in the bridge acts to charge the load coil 390 including the joint resistance (R_{J}). Therefore, we can derive the voltage required as:

$${V}_{C , Req}^{k} ( {I}_{L}^{k} , {I}_{S , M}^{k} ) \approx {V}_{Coil}^{k} ( {I}_{L}^{k} , {I}_{S , M}^{j} ) + ( {I}_{L}^{k} + \frac{{V}_{Coil}^{k} ( {I}_{L}^{k} , {I}_{S , M}^{j} ) {t}_{Charge}}{2 {L}_{Coil}} ) {R}_{L} \qquad ( Equation 7 )$$

$${V}_{C , Req}^{k} ( {I}_{L}^{k} , {I}_{S , M}^{k} ) \approx {V}_{Coil}^{k} ( {I}_{L}^{k} , {I}_{S , M}^{j} ) ( 1 + \frac{{t}_{Charge}}{2 {L}_{Coil}} {R}_{L} ) + {I}_{L}^{k} {R}_{L}$$

$${V}_{C , Req}^{k} ( {I}_{L}^{k} , {I}_{S , M}^{k} ) \approx \frac{{L}_{Coil} ( Δ {I}_{L} + {I}_{L}^{k} ( 1 - γ ) + {KI}_{S , M}^{j} )}{γ {t}_{Charge}} ( 1 + \frac{{t}_{Charge}}{2 {L}_{Coil}} {R}_{L} ) + {I}_{L}^{k} {R}_{L}$$

All the above working is to establish how the required voltage changes with time to handle the charging of the load 390. This became a linear problem by three assumptions:
1. The charging voltage generated may be characterised by the time-averaged voltage during the charging phase;
2. There is a minimal change in voltage generated in the maintenance phase; and
3. The secondary current generated in the maintenance phase does not change significantly between cycles.

In certain forms, these assumptions may be eradicated by a comprehensive characterisation phase were all possible variations in

$${I}_{L}^{k}$$

and ΔI_{L} to be characterised. This forms a large data array or look-up table. Instead, in other forms, the control method handles these second order effects by implementing a feedback mechanism, for example a PID loop, based on a comparison of the target value and the required value, as discussed later. For now, this potential difference will be modelled by the factor

$$ξ ( {I}_{S , C}^{k} , {I}_{S , M}^{k} , {I}_{L}^{k} )$$

as described below.

Having established the required target voltage

$$( {V}_{C , Req}^{k} ( {I}_{L}^{k} , {I}_{S , M}^{k} ) )$$

to be generated across the bridge switch in the charging phase, we must now consider how the voltage is generated in a TRFP 100. For a TRFP 100 comprising a rectifier 320 with a switching assembly 330 comprising switches 332 of the type in which a magnetic field is applied to suppress the critical current and to effect switching as the result of this suppression (which may be referred to as a “J_{C}(B) TRFP” for the purposes of this description), the voltage charging the load 390 may be completely determined by the voltage generated in the bridge

$${V}_{B} ( {I}_{B}^{k} ) .$$

For the circuit in FIGS. 3B to 3D, for example, all the voltage generated in the bridge charges the load 390. This scenario may be true for many forms of TRFP 100 as the joints may exist explicitly within the bridge. The corollary of this is that, for a J_{C}(B) TRFP, it may be highly (e.g. 100%) efficient in converting the voltage generated in the secondary coil 304

$$( {V}_{S , C} ( {I}_{S , C}^{k} , {I}_{L}^{k} ) )$$

of the transformer 150 into the voltage charging the load 390:

$${V}_{S , C} ( {I}_{S , C}^{k} , {I}_{L}^{k} ) = {V}_{B} ( {I}_{B}^{k} )$$

For the exemplary case outlined above:

$${V}_{B} ( {I}_{B}^{k} ) = {V}_{Sw , B} ( {I}_{B}^{k} ) + {I}_{B}^{k} {R}_{J}$$

As shown above, in certain forms, to charge at ΔI_{L}, the secondary coil 304 of the transformer 150 must generate

$${V}_{C , Req}^{k} ( {I}_{L}^{k} , {I}_{S , M}^{k} ) : {V}_{S , C} ( {I}_{L}^{k} , {I}_{B}^{k} ) = {V}_{C , Req}^{k} ( {I}_{L}^{k} , {I}_{S , M}^{k} ) + ξ ( {I}_{S , C}^{k} , {I}_{S , M}^{k} , {I}_{L}^{k} )$$

leading to:

$${V}_{B} ( {I}_{B}^{k} ) + {I}_{B}^{k} {R}_{J} = {V}_{Coil}^{k} ( {I}_{L}^{k} , {I}_{S , M}^{j} ) ( 1 + \frac{{t}_{Charge}}{2 {L}_{Coil}} {R}_{L} ) + {I}_{L}^{k} {R}_{L} + ξ ( {I}_{S , C}^{k} , {I}_{S , M}^{k} , {I}_{L}^{k} ) \qquad ( Equation 8 )$$

Where

$${V}_{Sw , B} ( {I}_{S , M}^{k} )$$

is defined by the non-linear resistivity response of the superconductor within the bridge:

$${V}_{Sw , B} ( {I}_{S , M}^{k} ) = {{V}_{0} ( \frac{{I}_{S , M}^{k}}{{I}_{Sw , C} ( B , T )} )}^{n ( B , T )}$$

where n determines the behaviour of the superconductor in its non-linear state and is dependent on the superconductor's magnetic field and temperature. Note that, until this point, the superconductors' non-linear behaviour has not interacted with the modelling analysis. Therefore, the above considerations would be the case for any TRFP 100 irrespective of the rectification mechanism. It is only now that, in certain forms in which the TRFP 100 is a J_{C}(B) TRFP, we utilise the J_{C}(B) mechanism which leads to equation 8 having the form:

$${CI}_{B}^{{k}^{n ( B , T )}} + {BI}_{B} = A + ξ ( {I}_{S , C}^{k} , {I}_{S , M}^{k} , {I}_{L}^{k} ) \qquad ( Equation 9 )$$

where

$$A = {V}_{C , Req}^{k} ( {I}_{L}^{k} , {I}_{S , M}^{k} ) , B = {R}_{J} and C = \frac{{V}_{0}}{{I}_{B , C}^{n}}$$

are constants.

One option is to solve equation 9 numerically using a defined n value. However, this is highly likely to be inaccurate due to the heating of the TRFP 100 during rectification causing n to change. Instead, in certain forms, we utilise an experimentally generated relationship between certain parameters, e.g. the characterisation tables outlined in section 6.4.5.1, in combination with the calculated target values. This approach enables the non-linear superconducting properties and second order effects (such as AC loss) to be embedded into the control process. This requires specific relationships between parameters (e.g. characterisation tables) to be generated from the characterisation phase to provide the data necessary for the application of the control process. Two distinct characterisation tables are required for the charging and maintenance phases, as explained earlier.

We now consider how to calculate target values for the maintenance phase. As before, using Kirchoff's loop law, the voltage generated by the transformer 150 in the maintenance phase is:

$${V}_{S , M} ( {I}_{S , M}^{k} , {I}_{L}^{k} ) = {V}_{Sw , S} ( {I}_{S , M}^{k} ) + ( {I}_{L}^{k} + Δ {I}_{L . C}^{k} + {I}_{S , M}^{k} ) {R}_{J} \qquad ( Equation 10 )$$

In contrast to the charging phase, the maintenance phase may only serve the purpose of stopping saturation of the transformer 150. In certain forms, this means that we require:

$${V}_{S , M} ( {I}_{S , M}^{k} , {I}_{L}^{k} + Δ {I}_{L . C}^{k} ) = {V}_{S , C} ( {I}_{L}^{k} , {I}_{B}^{k} ) \qquad ( Equation 11 )$$

therefore:

$${V}_{Sw , S} ( {I}_{S , M}^{k} ) + ( {I}_{L}^{k} + {I}_{S , M}^{k} + Δ {I}_{L . C}^{k} ) {R}_{J} ≅ {V}_{Coil}^{k} ( {I}_{L}^{k} , {I}_{S , M}^{j} ) ( 1 + \frac{{t}_{Charge}}{2 {L}_{Coil}} {R}_{L} ) + {I}_{L}^{k} {R}_{L} \\ {V}_{Sw , S} ( {I}_{S , M}^{k} ) + {I}_{S , M}^{k} {R}_{J} ≅ {V}_{Coil}^{k} ( {I}_{L}^{k} , {I}_{S , M}^{j} ) ( 1 + \frac{{t}_{Charge}}{2 {L}_{Coil}} {R}_{L} ) - Δ {I}_{L . C}^{k} {R}_{J} + ( {R}_{L} - {R}_{J} ) {I}_{L}^{k} \\ {V}_{Sw , S} ( {I}_{S , M}^{k} ) + {I}_{S , M}^{k} {R}_{J} ≅ {V}_{Coil}^{k} ( {I}_{L}^{k} , {I}_{S , M}^{j} ) ( 1 + \frac{{t}_{Charge}}{{L}_{Coil}} ( \frac{{R}_{L}}{2} - {R}_{J} ) ) + ( {R}_{L} - {R}_{J} ) {I}_{L}^{k}$$

Rearranging into constants over the cycle, the right-hand side becomes the required voltage for stopping core saturation over a cycle:

$${V}_{M , Req}^{k} ( {I}_{L}^{k} , {I}_{S , M}^{k} ) ≅ {V}_{Coil}^{k} ( {I}_{L}^{k} , {I}_{S , M}^{j} ) ( 1 + \frac{{t}_{Charge}}{{L}_{Coil}} ( \frac{{R}_{L}}{2} - {R}_{J} ) ) + ( {R}_{L} - {R}_{J} ) {I}_{L}^{k} {V}_{M , Req}^{k} ( {I}_{L}^{k} , {I}_{S , M}^{k} ) = \frac{{L}_{Coil} ( Δ {I}_{L} + {I}_{L}^{k} ( 1 - γ ) + {KI}_{S , M}^{j} )}{γ {t}_{Charge}} ( 1 + \frac{{t}_{Charge}}{{L}_{Coil}} ( \frac{{R}_{L}}{2} - {R}_{J} ) ) + ( {R}_{L} - {R}_{J} ) {I}_{L}^{k} \qquad ( Equation 12 )$$

It might appear slightly confusing that we have two different required voltages despite starting with the assumption that the voltages should be equal (equation 8). However, it is important to understand that the required voltages are solely focused on the superconducting switching elements 332 and not the total voltage generated in the secondary coil 304 of the transformer 150, which remains in equation 10. Note that the required maintenance phase voltage increase

$$( {V}_{M , Req}^{k} ( {I}_{L}^{k} , {I}_{S , M}^{j} ) )$$

is reduced by factors related to R_{J}. These, in turn, depend on how the current is distributed through the bridge. This is not considered clear a priori.

As in the charging phase, having established the required target values, we must establish the process for converting these into the actual inputs required for the TRFP. We assume that the superconducting switch element is based on J_{c}(B) rectification, therefore, the voltage in the switch 332a is determined using a power law:

$${V}_{Sw , S} ( {I}_{S , M}^{k} ) = {{V}_{0} ( \frac{{I}_{S , M}^{k}}{{I}_{Sw , S} ( B , T )} )}^{n ( B , T )}$$

meaning that equation 10 has the form:

$${V}_{M} = {{DI}_{S , M}^{k}}^{n ( B , T )} + {EI}_{S , M}^{k} = F + ξ ( {I}_{S , C}^{k} , {I}_{S , M}^{k} , {I}_{L}^{k} ) \qquad ( Equation 13 )$$

where

$$D = \frac{{V}_{0}}{{{I}_{Sw , S}}^{n ( B , T )}} , E = {R}_{J} and F = {V}_{Required}^{M} ( {I}_{L}^{k} , {I}_{S , M}^{k} ) .$$

As in the charging phase, this equation can either be solved numerically or the left-side of the equation may be characterised experimentally. In certain forms of the technology, the latter approach may be taken.

### 6.4.6.2. Calculation of Waveform Values—Half-Wave Rectifier

There now follows a description of how, in certain forms of the technology, a pre-calculated set of waveform values of the supply of the applied currents to the primary coil 204 and/or magnetic field generator 342 of the TRFP 100 may be determined. In other forms of the technology, some of these waveform values may be generated during the charging process.

To overcome the circularity issue previously highlighted, a predicted value for the peak current generated in the maintenance phase may be generated. In one form, this value is set as being equal to the value of the critical current of the length of superconducting material forming the series switch 332a, i.e.

$${I}_{S , M}^{x} = {I}_{C , M} ( B , T ) .$$

A more general approach may be to add an additional component (α) to I_{C,M} (B, T) where α may be determined by the required ramp rate. In either approach, the chosen initial value is used to calculate

$${V}_{M , Req}^{k} ( 0 , {I}_{C , M} ( B , T ) + α )$$

using equation 12. This value in turn is used to derive the waveform variations necessary. It should be noted that no other estimations may be required.

In a subsequent step, equation 7 is used to calculate a target value of the voltage across the bridge (e.g. across the bridge switch 332b in the form shown in FIGS. 3B-3E) in the charging phase of the first cycle that is required to achieve the desired charging of the load 390, i.e.

$${V}_{C , Req}^{1} ( {I}_{L}^{1} = 0 A , {I}_{C , M} ( B , T ) + α )$$

using the known resistances and the user defined

$${I}_{L}^{k}$$

and ΔI_{L} with the

$${I}_{S , M}^{1}$$

estimate.

Next, the calculated

$${V}_{C , Req}^{1}$$

is compared to the values of current for the corresponding voltage determined when characterising the response of the TRFP 100 using a characterisation supply, e.g. using the charging look-up table (Table 3), and if necessary interpolating, to find the I_{P,C} which generates

$${V}_{C , Req}^{1} .$$

This value is set as the value for the peak positive current for the waveform for the supply of applied current to the primary coil 204 in the first cycle, i.e.

$${I}_{P , C}^{1} .$$

The next step is to calculate a target value of the voltage across the series switch 332a in the maintenance phase of the first cycle that is required to achieve the desired charging of the load 390. For example, using equation 12, we may calculate

$${V}_{M , Req}^{1} ( {I}_{L}^{1} = 0 A , {I}_{C , M} ( B , T ) + α )$$

using the known resistances and the user defined

$${I}_{L}^{k}$$

and ΔI_{L} with the

$${I}_{S , M}^{1}$$

estimate.

Then, the calculated

$${V}_{M , Req}^{1}$$

is compared to the values of current for the corresponding voltage determined when characterising the response of the TRFP 100 using a characterisation supply, e.g. using the maintenance look-up table (Table 4), and if necessary interpolating, to find the I_{P,M} which generates

$${V}_{M , Req}^{1} .$$

This value is set as the value for the peak negative current for the waveform for the supply of applied current to the primary coil 204 in the first cycle, i.e.

$${I}_{P , M}^{1} .$$

The above steps (with the exception of the first step) may be subsequently repeated a plurality of times based on the selected increments ΔI_{L} of load current up to the target load current I_{target}.

Table 5 below shows an example of this series of calculations being carried out and the results populated in a look-up table.

TABLE 5
exemplary table of target values for charging a load using a TRFP

| k | ${I}_{L}^{k} ( A )$ | ${I}_{S , M}^{k} ( A )$ | ΔI_{L} (A) | ${V}_{C , Req}^{k} ( {I}_{L}^{k} , {I}_{S , M}^{j} )$ (V) | ${V}_{M , Req}^{k} ( {I}_{L}^{k} , {I}_{S , M}^{j} )$ (V) | ${I}_{P , C}^{k}$ (A) | ${I}_{S , M}^{j}$ (A) | ${I}_{P , M}^{k}$ (A) |
|---|---|---|---|---|---|---|---|---|
| 1 | 0 | I_{C,M} (B, T) + α | 0.1 | ${V}_{C , Req}^{1} ( {I}_{L}^{1} = 0 A , {I}_{C , M} ( B , T ) + α ) = 0.5$ | ${V}_{M , Req}^{1} ( {I}_{L}^{1} = 0 A , {I}_{C , M} ( B , T ) + α ) = 0.48$ | 2.02 | 102.01 | 1.98 |
| 2 | 0.1 | 102.01 | 0.1 | ${V}_{C , Req}^{2} ( {I}_{L}^{2} = 0.1 A , {I}_{S , M}^{2} = 102 ) = 0.505$ | ${V}_{M , Req}^{2} ( {I}_{L}^{2} = 0.1 A , {I}_{S , M}^{2} = 102 ) = 0.482$ | 2.021 | 102.04 | 1.99 |
| 3 | 0.2 | 102.04 | 0.1 | ${V}_{C , Req}^{3} ( {I}_{L}^{3} = 0.2 A , {I}_{S , M}^{3} = 102.04 ) = 0.508$ | ${V}_{M , Req}^{3} ( {I}_{L}^{3} = 0.2 A , {I}_{S , M}^{3} = 102.04 ) = 0.483$ | 2.022 | 102.08 | 2.00 |
| . . . | . . . | . . . | . . . | . . . | . . . | . . . | . . . | . . . |
| Z | I_{Target} | 102.9 | 0.1 | 1.77 | 1.64 | 3.24 | 103.12 | 2.14 |

To clarify how this table may be populated, for the k^{th} row:
1. The value of

$${I}_{L}^{k}$$

is determined by summing the previous value of the load current and ΔI_{L}, i.e.

$${I}_{L}^{k} = {I}_{L}^{k - 1} + Δ {I}_{L} .$$

2. The value of

$${I}_{S , M}^{k}$$

is the value of

$${I}_{S , M}^{x}$$

from the (k−1)^{st} row;
3. The values of

$${V}_{C , Req}^{k} and {V}_{M , Req}^{k}$$

are determined using the formulas shown in the table; and
4. The values of

$${I}_{P , C}^{k} and {I}_{P , M}^{k}$$

are determined from the corresponding values of

$${V}_{C , Req}^{k} and {V}_{M , Req}^{k}$$

in the same row and using the appropriate look-up table (i.e. either Table 2 or Table 4).

In certain forms, these steps may be performed in order to determine a target charging regime, for example the regime as set out in a data array of look-up table such as Table 5, before charging of the load 390 commences. In other forms, calculation, or re-calculation, of the target values may occur dynamically during the process of charging the load 390, i.e. after charging of the load 390 commences, i.e. the above steps may be performed, and may be repeated, at one or more times during charging of the load 390, for example after conclusion of one or more of the charging cycles.

### 6.4.6.3. Modelling of a Centre-Tapped Full-Wave Rectifier

The detailed examples given in the above description relates to the modelling of a rectifier 320 in the form of a half-wave rectifier 320 such as shown in FIGS. 3B-3E. It has been explained that, in some forms of the technology, rectifiers of other types may form part of the TRFP 100. In this section, we will discuss adaptations to an exemplary method of current control that may be used in the case of a rectifier 320 in the form of a full-wave rectifier.

In a full-wave rectifier, both the positive and negative parts of the waveform of the applied current supplied to the primary coil 204 act to charge the load 390. This may be more energy efficient than in the case of a half-wave rectifier, and may also significantly reduce current ripple. Also, and importantly for the control process, the asymmetry between the two parts of the cycle is significantly reduced and, as an approximation, it might be considered to be insignificant. In reality, the initial (e.g. positive) part of the cycle may generate a DC offset that causes a slight asymmetry between the positive and negative charging phases. This offset may cause variations in charging rate between the positive and negative parts of the cycle and may be accounted for in some forms of the technology. In some forms, the offset may naturally rectify itself, as will be assumed in the upcoming analysis.

In addition to the reduced asymmetry within a charging cycle, in a centre-tapped full-wave rectifier the load current may be distributed evenly between the transformer sections, unlike in a half-wave rectifier. This leads to an inescapable DC offset in the secondary current. However, as the nature of this offset is distinct from the action of the transformer, the offset in one section of the transformer may be perfectly counteracted by the offset in the other section of the transformer. Therefore, while the load current distribution influences the current generated in the secondary circuit, it may not saturate the transformer. As this offset is directly related to load current it may be relatively straightforward to counteract. As shown below, in certain forms, it may be handled by the addition of a

$$\frac{1}{2} {I}_{L}$$

term into the target value table.

Detailed analysis for a full-wave rectifier is not presented here but will be able to be determined by the skilled addressee by following the analysis presented above for the example of a half-wave rectifier. By way of example, in the case of a TRFP 100 comprising a rectifier 320 in the form of a centre-tapped full-wave rectifier, for example of the type shown in FIG. 4 and FIGS. 16, 17, 21, 22, 26, 27, 29 and 30 of PCT Application No. PCT/NZ2022/050009, published as International Publication No. WO 2022/164330, the contents of which are herein incorporated by reference.

To highlight the ubiquity and use of the target value approach, we present the final required target value equation for a centre-tapped full-wave rectifier without derivation. For simplicity, we focus on a set of assumptions which reduce the complexity of the target value equations. These are:
no load resistance: R_{L}=0;
no requirement for constant ΔI_{L}: instead a constant voltage is used to define the target value in each cycle: V_{Set};
no attempt to counteract the DC offset: both the positive and negative sections of the primary waveform are scaled identically and have the same peak current: I_{S};
no attempt to integrate additional physical components such as AC loss;
use of analytical solutions rather than comparison experimentally look-up tables. In the case of the assumptions above, the analytical method reduces to a simple calculation without the necessity for numerical approaches. The look-up table approach may provide more robust control in some forms, in other forms, analytical methods may be sufficient.

Utilising these assumptions, the centre-tapped full-wave flux pump target value equation for

$${I}_{P}^{k}$$

becomes:

$${I}_{P}^{k} = \frac{2 {N}_{2}}{{N}_{1}} ( {I}_{Sw , c} \sqrt[n ( B )]{\frac{{V}_{Set} + {I}_{L} {R}_{J}}{{E}_{0} {I}_{S}}} + \frac{1}{2} {I}_{L} )$$

### 6.4.7. Modifying the Primary Current Supply

When the TRFP 100 is used to charge load 390 based on the target values calculated, for example as explained above, the TRFP 100 may not behave precisely as modelled. A number of assumptions and simplifications were used in the above analysis, which may mean that a number of modifications to the target voltages

$${V}_{C , Req}^{k} and {V}_{M , Req}^{k} ,$$

and consequently to the waveform values of the applied current, will be needed to achieve the desired performance of the TRFP 100, which may include charging the load with a charging rate consistent with ΔI_{L} and a net zero flux across the cycle.

In the analysis above, these assumptions/simplifications were incorporated into a single component

$$ξ ( {I}_{S , C}^{k} , {I}_{S , M}^{k} , {I}_{L}^{k} ) .$$

This component is difficult to handle a priori due to the potential interactions between a range of parameters. Therefore, in certain forms of the invention, the method of controlling the supply of applied current to the primary coil 204 comprises modifying the target values for the supply of applied current during the charging process, i.e. after the charging of the load 390 has commenced, which may be referred to as dynamic control of the supply of applied current. In some forms of the technology, the supply of applied current may be modified based on feedback received from the TRFP 100, e.g. from one or more sensors configured to measure values of the TRFP 100, for example the secondary side 300. In certain forms, the feedback modifying the supply of applied current may comprise a comparison of one or more target values to one or more experimentally measured values of the TRFP 100.

In certain forms, one or both of two comparisons may be used as a basis on which to modify the supply of applied current:
1. Modifying the peak positive value of the supply of applied current

$${I}_{P , C}^{k}$$

due to

$$Δ {I}_{L}^{k} ( Measured ) - Δ {I}_{L} ( User Defined ) = ω .$$

This step may help to ensure that the desired ramp rate is achieved each time the modification is performed, e.g. each cycle; and
2. Modifying the peak negative value of the supply of applied current

$${I}_{P , M}^{k}$$

due to

$${V}_{S , C}^{k} ( Measured ) - {V}_{S , M}^{k} ( Measured ) = ε .$$

Again the supply of applied current may consequently be modified based on this recalculated, modified target value. This step may help to prevent the transformer 150 from saturating.

Modifying the supply of applied current in the manner described may occur after each cycle of the supply of applied current. Alternatively, it may occur on a regular but less frequent basis, for example after a certain number of cycles. Alternatively, the modification may occur on an irregular basis.

The modification resulting from the feedback may be implemented in different ways in different forms of the technology. For example, the following options may be used:
1. Modifying the existing waveform values based on analytically-derived properties of the TRFP;
2. Modifying the existing waveform values by using a PID loop; or
3. Replacing the waveform values by recalculating the target values on a recurring basis, e.g. each cycle.

Each of these options will now be described in more detail.

### 6.4.7.1. Analytically-Derived Properties

In certain forms of the technology, certain assumptions may simplify the analysis set out above and be sufficiently valid that they be useful for applying an analytical approach to determining what modification to the supply of alternating current may be needed.

For example in the case of a TRFP 100 comprising a rectifier 320 in the form of a full-wave rectifier, it may in some circumstances be able to be assumed that the joint resistance R_{J} and temperature dependence of the behaviour of the superconductor may be negated, in which case equation 9 would simply become:

$${CI}_{B}^{{k}^{n}} = G$$

where

$$G \approx \frac{{L}_{Coil} ( Δ {I}_{L} + ω + {I}_{L}^{k} ( 1 - γ ) )}{γ {t}_{Charge}} ( 1 + \frac{{t}_{Charge}}{2 {L}_{Coil}} {R}_{L} ) + {I}_{L}^{k} {R}_{L} and C = \frac{{V}_{0}}{{I}_{B , {C}^{n}}} .$$

This may be solved directly for

$${I}_{B}^{k} \text{:} {I}_{B}^{k} = \sqrt[n]{\frac{G}{C}}$$

This can then be converted into the following equation for determining the required peak alternating supply current

$${I}_{P , C}^{k} \text{:} {I}_{P , C}^{k} = \frac{{N}_{2}}{{N}_{1}} ( {I}_{B}^{k} + {I}_{L}^{k} )$$

It is considered that analytically determining how to modify the supply of applied current for a rectifier 320 in the form of a half-wave rectifier, for example of the type illustrated in FIGS. 3B to 3E may be too inaccurate for a practically implementable solution. The non-linearity of the superconducting switches mean, for example, that changes in the physical properties of the superconducting elements, such as temperature, may lead to significant changes in the output voltage causing significant discrepancy between the calculated and measured response.

### 6.4.7.2. PID Loops

In certain forms, the current control mechanism 203 may be configured to perform one or more PID loops and modifying the supply of applied current may comprise using the PID loop(s) to provide feedback from the secondary side 300 to control the current.

In some forms of the technology, for example in forms in which the rectifier 320 takes the form of a half-wave rectifier and there is a charging and maintenance phase in the current cycle, the current control mechanism 203 may be configured to perform two PID loops, one for each phase. In the first PID loop, the current control mechanism 203 may be configured to control the peak positive value of the supply of applied current

$${I}_{P , C}^{k}$$

relative to ω, as defined above. In the second PID loop, the current control mechanism 203 may be configured to control the peak negative value of the supply of applied current

$${I}_{P , C}^{k}$$

relative to ε, as defined above.

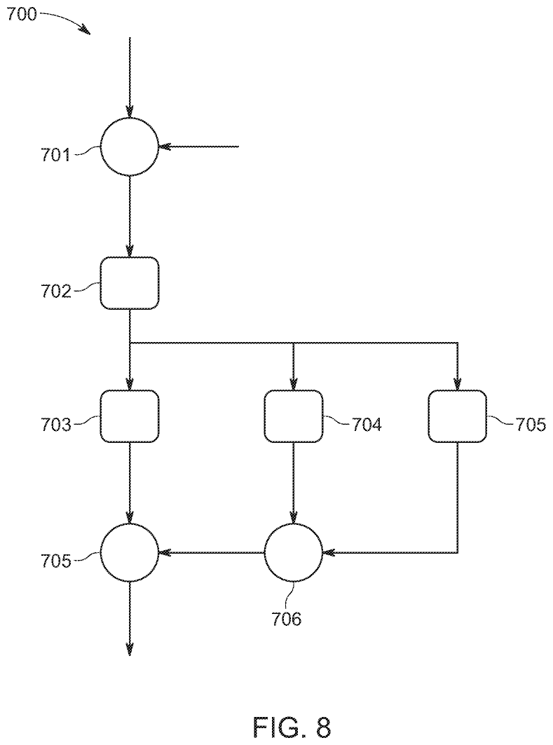

FIG. 8 is a flow chart diagram of the process performed by the current control mechanism 203 when performing a method 700 to implement one or both of the PID loops according to certain forms of the technology. There may be two inputs to the method 700, for example in the case of the PID loop to control the peak positive value of the supply of applied current

$${I}_{P , C}^{k}$$

relative to ω, the inputs may be the values

$$Δ {I}_{L}^{k} ( Measured )$$

and ΔI_{L}(User Defined) as explained above. In the case of the PID loop to control the peak negative value of the supply of applied current

$${I}_{P , M}^{k}$$

relative to ε, the inputs may be the values

$${V}_{S , C}^{k} ( Measured ) and {V}_{S , M}^{k} ( Measured )$$

as explained above. At step 701, a difference value 702 between the input values may be calculated, e.g. the values ω and ε may be determined. At steps 703, 704 and 705, correction terms are determined from the difference value 702 which are proportional, integral and derivative terms respectively. These terms are summed at steps 706 and 705 to determine the output of the PID loop, e.g. the peak positive value of the supply of applied current

$${I}_{P , C}^{k + 1}$$

for the subsequent cycle and the peak negative value of the supply of applied current

$${I}_{P , M}^{k + 1}$$

for the subsequent cycle.

In certain forms, the ways in which the proportional, integral and derivative terms are calculated may be experimentally derived, for example through the Ziegler-Nichols method, or any other suitable method. The terms may also be gain-scheduled.

The calculation of the waveform values using the method explained above may deal with the non-linearity of the superconductor switches so that the modifications required to be made through the PID control process may be small and approximately linear.

To make satisfactory use of PID loop control, it may be useful to perform extensive characterisation of the response of the TRFP 100, such as explained above. It is anticipated that, once the TRFP 100 has been characterised, the characterisations should remain consistent for significant periods in certain forms.

### 6.4.7.3. Recalculation of Waveform Values

In other forms, the target values of the supply of applied current to the primary coil 304 may be re-calculated on a recurring basis, for example regularly, for example each cycle. This approach may, in some forms, avoid the need to pre-calculate the full set of waveform values of the supply of applied current initially, e.g. a look-up table such as table 5 above may not need to be generated, or may only need to be partly generated.

In the case of a TRFP 100 comprising a rectifier 320 in the form of a half-wave rectifier, for example as shown in FIGS. 3B to 3E, the results of a previous cycle may be reinputted into the equations above with modifications related to ω and ε. For ω, this involves changing equation 2 as follows:

$$Δ {I}_{L . C}^{k} - ω = \frac{{V}_{Coil , C}^{k} {t}_{Charge}}{{L}_{Coil}}$$

Running through the related algebra, equation 5 becomes:

$${V}_{Coil , C}^{k} ( {I}_{L}^{k} , {I}_{S , M}^{j} ) ≅ \frac{{L}_{Coil} ( Δ {I}_{L} - ω + {I}_{L}^{k} ( 1 - γ ) + {KI}_{S , M}^{j} )}{γ {t}_{Charge}}$$

Therefore, in these forms, the feedback control for the positive peak value of the supply of applied current may be handled by the empirically derived ω subtlely manipulating the

$${I}_{P , C}^{k}$$

value each cycle.

For feedback control using ε, the

$$ξ ( {I}_{S , C}^{k} , {I}_{S , M}^{k} , {I}_{L}^{k} )$$

in equation 13 is simply replaced by ε:

$${DI}_{S , M}^{{k}^{n ( B , T )}} + {EI}_{S , M}^{k} = F + ε$$

where

$$D = \frac{{V}_{0}}{{I}_{Sw , S}^{n ( B , T )}} , E = {R}_{J} and F = {V}_{Required}^{M} ( {I}_{L}^{k} , {I}_{S , M}^{k} )$$

where

$${V}_{M , Req}^{k} ( {I}_{L}^{k} , {I}_{S , M}^{k} ) = \frac{{L}_{Coil} ( Δ {I}_{L} - ω + {I}_{L}^{k} ( 1 - γ ) + {KI}_{S , M}^{j} )}{γ {t}_{Charge}} ( 1 + \frac{{t}_{Charge}}{{L}_{Coil}} ( \frac{{R}_{L}}{2} - {R}_{J} ) ) + ( {R}_{L} - {R}_{J} ) {I}_{L}^{k}$$

As indicated above, in this form of the technology, the waveform values are calculated regularly, e.g. in between each cycle, using the updated

$${V}_{M , Req}^{k} ( {I}_{L}^{k} , {I}_{S , M}^{k} ) and {V}_{C , Req}^{k} ( {I}_{L}^{k} , {I}_{S , M}^{k} )$$

equations above. Limitations in processing speed may hinder the viability of this approach, particularly as frequency is increased. However, the calculations and interpolation from a pre-existing loop-up table are relatively simple for a processor to perform and research has indicated that this approach should not be a major limitation in the time response of the control process.

### 6.4.8. Persistent Mode

In certain forms, once the load 390 has been sufficiently charged, for example, the load current has reached the target value of load current I_{target}, the TRFP 100 may be operated in persistent mode. In this mode, the charge of the load 390 may be maintained, and the load current may be maintained at I_{target}.

In persistent mode, the load current supplied to the load 390 does not increase, i.e. ΔI_{L}=0, therefore, from the earlier equations:

$$Δ {I}_{L , M}^{k} = Δ {I}_{L . C}^{k}$$

$${V}_{Persistent}^{k} ( {I}_{L}^{k} , {I}_{S , M}^{k - 1} ) ≅ \frac{{L}_{Coil} γ ( {I}_{L}^{k} + {KI}_{S , M}^{k - 1} ) )}{{t}_{Charge} ( 1 - γ )}$$

$${V}_{C , Req}^{k} ( {I}_{L}^{k} ) = {V}_{Persistent}^{k} ( {I}_{L}^{k} , {I}_{S , M}^{k - 1} ) ( 1 + \frac{{t}_{Charge}}{2 {L}_{Coil}} {R}_{L} ) + {R}_{L} {I}_{L}^{k}$$

$${V}_{M , Req}^{k} ( {I}_{L}^{k} ) = {V}_{Persistent}^{k} ( {I}_{L}^{k} , {I}_{S , M}^{k - 1} ) ( 1 + \frac{{t}_{Charge}}{{L}_{Coil}} ( \frac{{R}_{L}}{2} - {R}_{J} ) ) + ( {R}_{L} - {R}_{J} ) {I}_{L}^{k}$$

In some forms, these equations are used to derive target values of voltage and consequently waveform values for the primary current waveform (e.g. using the look-up tables) for sustaining the TRFP 100 in the persistent mode.

### 6.5. Other Remarks

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The technology may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the technology and without diminishing its attendant advantages. It is therefore intended that such changes and modifications be included within the present technology.

1. A method of controlling a supply of applied current to a transformer-rectifier flux pump to charge a load,
wherein the transformer-rectifier flux pump comprises:
a transformer comprising a primary coil and a secondary coil; and
a rectifier connected to the secondary coil and configured to supply a load current to a load;
wherein the secondary coil, the rectifier and the load comprise one or more lengths of type II superconducting material,
wherein the method comprises:
calculating, for each of a plurality of target values of load current to be supplied to the load, one or more waveform values of the supply of applied current to the transformer-rectifier flux pump; and
controlling the supply of applied current to charge the load on the basis of the one or more waveform values.

2. The method of claim 1, wherein the method comprises calculating the one or more waveform values of the supply of applied current to the transformer-rectifier flux pump for target values of load current at one or more pre-selected increments up to a pre-selected target value of the load current.

3. The method of claim 1, wherein the one or more waveform values of the supply of applied current to the transformer-rectifier flux pump comprise a peak value of the supply of applied current when flowing in a first direction, and a peak value of the supply of applied current when flowing in a second direction, the second direction being opposite to the first direction.

4. The method of claim 1, wherein the method of calculating the waveform values of the supply of applied current to the transformer-rectifier flux pump comprises:
calculating, for each of the plurality of target values of load current to be supplied to the load, one or more target voltage values for the transformer-rectifier flux pump; and
calculating the one or more waveform values of the supply of applied current to the transformer-rectifier flux pump from the one or more target voltage values.

5. The method of claim 4, wherein the one or more target voltage values comprise target values of voltage output to the load.

6. The method of claim 5, wherein the target values of voltage output to the load comprise target values of voltage across a switch connected in parallel across the load.

7. The method of claim 4, wherein the one or more target voltage values comprise:
first target values of voltage output to the load when the rectifier is in a first configuration in which a current generated in the secondary coil is supplied to the load; and
second target values of voltage output to the load when the rectifier is in a second configuration in which no current is supplied from the secondary coil to the load.

8. The method of claim 1, wherein the method comprises supplying a characterisation supply of applied current to the transformer-rectifier flux pump, characterising a response of the rectifier and/or the load to the characterisation supply, and controlling the supply of applied current to charge the load based on the characterised response.

9. The method of claim 8, wherein the method comprises supplying the characterisation supply and characterising the response to the characterisation supply prior to commencing the supply of applied current to the transformer-rectifier flux pump to charge the load.

10. The method of claim 8, wherein the step of supplying the characterisation supply comprises:
supplying a first characterisation supply of applied current to the transformer-rectifier flux pump when the rectifier is in a first configuration in which a current generated in the secondary coil is supplied to the load, and characterising a first response of the rectifier and/or the load to the first characterisation supply; and
supplying a second characterisation supply of applied current to the transformer-rectifier flux pump when the rectifier is in a second configuration in which no current is supplied from the secondary coil to the load, and characterising a second response of the rectifier and/or the load to the second characterisation supply.

11. The method of claim 8, wherein characterising the response of the rectifier and/or the load to the characterisation supply comprises determining a plurality of values of voltage in the rectifier corresponding to a respective plurality of values of applied current supplied to the primary coil.

12. (canceled)

13. (canceled)

14. The method of claim 1, wherein the method further comprises modifying the supply of applied current to the transformer-rectifier flux pump during the process of charging the load.

15. The method of claim 14, wherein the supply of applied current is modified based on feedback received from one or more sensors configured to measure values of the transformer-rectifier flux pump.

16. The method of 15, wherein the feedback comprises a comparison of target values and measured values of the transformer-rectifier flux pump.

17. The method of claim 1, wherein the one or more waveform values are values of current supplied to the primary coil.

18. (canceled)

19. An apparatus for controlling a supply of applied current to a transformer-rectifier flux pump to charge a load, the apparatus comprising a processor configured to perform the method of claim 1.

20. A transformer-rectifier flux pump comprising:
a transformer comprising a primary coil and a secondary coil; and
a rectifier connected to the secondary coil and configured to supply a load current to a load,
wherein the secondary coil, the rectifier and the load comprise one or more lengths of type II superconducting material,
wherein the transformer-rectifier flux pump further comprises:
a current control mechanism for controlling a supply of applied current to the primary coil, wherein the current control mechanism is configured to perform the method of claim 1.

21. The transformer-rectifier flux pump of claim 20, wherein the rectifier comprises a switching assembly comprising one or more switches.

22. The transformer-rectifier flux pump of claim 20, wherein each switch comprises a length of type II superconducting material configured to carry a switch current, wherein the length of type II superconducting material has a critical current,
wherein the transformer-rectifier flux pump further comprises one or more magnetic field generators each configured to apply a magnetic field to the length of type II superconducting material of the respective switch, wherein each magnetic field generator is configured to be selectively controlled to switch the length of superconducting material between a low-resistance state and a higher resistance state.

23. The transformer-rectifier flux pump of claim 22, wherein, in the low-resistance state, a magnitude of the magnetic field is relatively low such that the switch current is substantially less than the critical current, and wherein, in the higher-resistance state, the magnitude of the magnetic field is relatively high to reduce the critical current such that the switch current approaches the critical current, is substantially equal to the critical current or is greater than the critical current of the length of superconducting material.

24. (canceled)
